(19) United States
(12) Patent Application Publication
(10) Pub. No.: US 2008/0052742 A1
(43) Pub. Date: Feb. 28, 2008

(54) Method and apparatus for presenting media content

(75) Inventors: Jared Kopf, San Francisco, CA (US); Jeremiah Robison, San Francisco, CA (US); Johnnie Manzari, San Francisco, CA (US); Max Levchin, San Francisco, CA (US); Michael Powers, San Francisco, CA (US)

Correspondence Address: PARK, VAUGHAN & FLEMING LLP, 2820 FIFTH STREET, DAVIS, CA, 95618, US

(73) Assignee: Slide, Inc., San Francisco, CA (US)

(21) Appl. No.: 11/899,939

(22) Filed: Sep. 5, 2007

Related U.S. Application Data
(63) Continuation-in-part of application No. 11/340,881, filed on Jan. 26, 2006.
Application No. 11/340,881 is a continuation-in-part of application No. 11/115,643, filed on Apr. 26, 2005.

(51) Int. Cl. H04N 7/025

(52) U.S. Cl. 725/34

(57) ABSTRACT

A method and apparatus for presenting media content. Media content items are presented in a media ticker or a client application having a graphical user interface. Each presented item is displayed at one end of the ticker and then scrolls or moves toward the other end where it is removed. A content item may be manipulated in the ticker, to obtain a larger view of the item, open an application to access (e.g., play) the item, save the item, transmit it to another user, etc. Visual content items may be represented in the ticker by thumbnails or other versions of the content; other types of content (e.g., audio, document, multimedia) items may be represented by icons indicating the type of content. Content items belong to content channels to which a user may subscribe or which other users may be invited to subscribe to.

### RELATED APPLICATIONS

This application is a continuation-in-part of U.S. patent application Ser. No. 11/340,881, which is entitled “Method and Apparatus for Presenting Media Content” and was filed Jan. 26, 2006 as a continuation-in-part of U.S. patent application Ser. No. 11/115,643, filed Apr. 26, 2005; both applications are incorporated herein by reference.

### BACKGROUND

This invention relates to the field of computer systems. More particularly, a system and methods are provided for presenting media content via a video display device (e.g., computer, television, telephone).

The Internet and the world-wide web provide unparalleled access to electronic information that can be presented in a manner comprehensible by humans. Such information may be generically referred to as “content,” and includes media and other data that are audio or visual in nature, graphical or textual, color or monochrome, stereo or monaural, etc.

Content is traditionally accessed on the Internet or world-wide web in an active manner. That is, a user typically navigates a browser to a world-wide web site that stores information that may be of interest to the user. At that site, the user may actively search for interesting information (e.g., by entering search terms, by navigating hyperlinks), review various content and may be redirected (or may further navigate) to other sites. Users may also access or generate content with a suitable application, such as a word processing, spreadsheet or graphics program.

In addition, a user's browser may itself be directed by software code on a web site to access information from another server, which information will be displayed by the browser as if it were being transmitted from the original web site even though, in fact, the content displayed is not found anywhere at the Uniform Resource Locator (“URL”) that identifies the original site. Yet further, users may access media via television by manipulating their televisions to access a particular channel, playing a recorded program, setting display parameters, etc.

Typically, a user's access to content requires a significant amount of interaction or activity on the user's part. Interaction may involve clicking a control on a mouse or other pointing device, typing on a keyboard, speaking into a microphone, manipulating various controls on a touch screen, operating a remote control, etc. In particular, content accessed by the user is specifically sought out and/or selected by the user.

However, the user may miss out on enjoyable content simply because he or she does not know of it. For example, a friend may have a collection of photographs, images, sounds and/or other content that the user may enjoy. The friend may want to share some or all of the content with the user, but without sharing it with other people, and it is unlikely (or maybe even impossible) for the user to find the content just by searching.

To avoid giving access to other people, the friend would generally not make personal content accessible in a public forum (where it could be browsed by the public or indexed by a search engine) and would likely refrain from employing any type of anonymous peer-to-peer application for sharing files. Transmitting the content directly to the user via electronic mail or a portable storage device would be inefficient, especially if additional (e.g., updated) photographs, images or other data may be forthcoming in the future.

Even if an individual is willing to make content available to a wide group of people (e.g., on a social networking site), it is difficult to make a large amount of information available for viewing in what is often a limited space, and even more difficult if the individual wishes to periodically update the provided content without having to redesign the entire presentation.

Thus, existing methods of accessing electronic data are not suitable for sharing a set of content between or among a limited number of users (or even an unlimited number of users who select a given “channel” of content), especially where the content may be modified or updated in the future. The greater the amount of content to be shared, the more difficult it becomes to share it in an efficient manner. The type(s) of device(s) on which the content may be accessed may further complicate the process. For example, making the content available for viewing on a user's television or mobile telephone may be more difficult than making it available on his or her computer monitor.

In short, existing methods of sharing personal content can require significant effort by the sharing party, to collect, assemble, package and transmit the content, and a recipient may be limited in how the content can be displayed or presented. For example, the content may only be accessible by a particular software program or may only be able to be rendered on a particular type of device.

For non-personal content, a commercial organization may wish to offer content to users without requiring their active participation (e.g., navigation to the organization's web site, selection of individual content items). The more activity required on a user's part, the less likely he or she may be to access the content or the less frequently she may access it. Moreover, if the content is dynamic, the users would likely have to access the organization's website (or other location) repeatedly to experience newer content.

### SUMMARY

In one embodiment of the invention, a method and apparatus are provided for presenting content (e.g., audio and/or visual content) and/or other electronic data to a user via a device capable of displaying or playing the content. Illustrative devices that may have suitable display components include televisions, computing devices (e.g., desktop computers, laptops), telephones, personal digital assistants, etc.

In this embodiment, content items are presented in a graphical user interface presented on the display. In one implementation, the user interface is configured as a media ticker in which a content item is presented in one position (e.g., at one end) of the ticker and then scrolls or moves toward another position (e.g., the other end), where it is removed.

The selection of content for presentation to a user may be driven by subscription. For example, the user may subscribe to any number of content channels, which may be published by organizations and/or other users. Any user may publish any content he or she chooses, for consumption by all users, a group of users satisfying some criteria, or just specifically selected users.

Content may also (or instead) be selected for presentation to a user based on the user's preferences, which may be explicitly identified by the user and/or may be learned by monitoring the user's interaction with other content, a media ticker, other users, etc. The user's preferences may be specified before any content is delivered, and/or while content is delivered or played in the ticker. Yet further, a content publisher may broadcast individual content items, groups of items and/or channels of content to one or more users.

Visual content items (e.g., images) may be represented in a media ticker by thumbnail images or other versions of the content configured to fit within the ticker. Other types of content (e.g., audio, multimedia, a document) may be represented by icons or pictures indicating the type of content. While displayed within the ticker, a content item may be able to be manipulated to obtain a larger view of the item, open an application to access (e.g., play) the item, save the item, transmit the item to another user, etc.

In one embodiment, a user may add individual content items and/or groups of items to his/her ticker, or remove them, as desired, and may exchange content items with another user via the ticker. Thus, by simply dragging a content item to (or from) his ticker, a user can increase (or decrease) the number of items that he shares with other users.

The extent to which a user is able to manipulate content items presented in a media ticker may depend upon the type of device on which the ticker is presented. For example, when the ticker is hosted on the user's computing device by a robust application program, the user may be able to control many aspects of the ticker (e.g., size, shape, position, orientation, other appearance characteristics) and its operation (e.g., speed with which items are scrolled, direction of scrolling, which channels are active). When the ticker is presented on another device (e.g., television, mobile telephone), the user's ability to manipulate the ticker may depend on the type of controls (e.g., remote control, buttons, keys) on the device.

In an embodiment of the invention, content items are divided into channels that may be distinguished by topic or theme, type of content, content source, publisher, etc. A user may maintain local channels comprising content he wishes to view or share, and may allow other users to subscribe to those channels. As described above, the user may also subscribe to any number of external content channels—channels published by other users and/or organizations.

Any number of local channels and subscribed channels may be active at a time, and the user's media ticker will present content items from any or all of the active channels. Items from different channels may be shuffled, presented in random order, in sequence based on publisher or channel, or may be presented in some other order.

In an embodiment of the invention, a local and/or central media guide or other interface is provided to manage the user's local channels (e.g., to add or remove content items, invite or allow subscribers to access a local channel) and/or subscriptions to external channels (i.e., channels managed by other users or organizations). The media guide may also provide access to other users' profiles, and allow one to subscribe to (or request to subscribe to) those users' local channels, send an individual content item to another user, etc.

A media ticker may therefore be used to passively enjoy media (e.g., images, sound files, animation) selected by the user or by someone else, with minimal or no action required by the user. The media ticker may also serve as a means of transmitting a content item (e.g., a photograph, a document, a song) from one user to another.

### DESCRIPTION OF THE FIGURES

FIG. 1 depicts a media ticker, in accordance with an embodiment of the present invention.

FIG. 2 depicts a media ticker and an expanded view of a content item presented in the ticker, in accordance with an embodiment of the invention.

FIG. 3 depicts a local media guide for managing a user's content channel subscriptions and user associations, in accordance with an embodiment of the present invention.

FIG. 4 depicts an interface for creating a new content channel, in accordance with an embodiment of the present invention.

FIG. 5 depicts an interface for accessing and/or altering a content channel, in accordance with an embodiment of the present invention.

FIG. 6 depicts a central media guide, in accordance with an embodiment of the present invention.

FIG. 7 is a block diagram of an apparatus for presenting media content, in accordance with an embodiment of the present invention.

FIG. 8 is a flowchart demonstrating a method of presenting media content to a user through a media ticker, in accordance with an embodiment of the present invention.

FIG. 9 is a block diagram of a client device configured to present content to a user via a media ticker, in accordance with an embodiment of the invention.

FIG. 10 depicts a media ticker according to one alternative embodiment of the invention.

FIG. 11 depicts an expanded content item from an item presented in the media ticker of FIG. 10.

FIG. 12 depicts an item insertion page accessible from the media ticker of FIG. 10.

FIG. 13 depicts a media guide accessible from the media ticker of FIG. 10.

FIG. 14 depicts a slide show creation page accessible from the media guide of FIG. 13.

FIGS. 15A-B depict a central media guide according to one alternative embodiment of the invention.

FIG. 16 depicts a group page accessible from the central media guide of FIGS. 15A-B.

FIG. 17 depicts a site page accessible from the central media guide of FIGS. 15A-B.

FIG. 18 depicts a slide show page accessible from the central media guide of FIGS. 15A-B.

FIG. 19 is a block diagram of an environment in which a media ticker may be presented on a user's television, according to one embodiment of the invention.

FIG. 20 is a flowchart demonstrating a method of presenting a media ticker on a television, according to one embodiment of the invention.

FIG. 21 depicts a media ticker as it may appear on a television, according to one embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

A method and apparatus are provided for presenting multimedia content to a user via a television, computer or other communication device (e.g., telephone, personal digital assistant). The content may include audio and/or visual data, and may be passively enjoyed by the user, but may also be manipulated by the user when presented. The manner and degree of manipulation may depend upon the type of device upon which or through which the content is presented.

Some embodiments of the invention are described herein as they may be implemented for use with a traditional computing device having a display (e.g., a desktop computer, a portable computer). However, these embodiments may be readily modified for implementation on other devices, such as a television, a handheld computing or communication device (e.g., a personal digital assistant, a smart telephone), and other devices configured to present electronic content to a user. Other embodiments of the invention presented herein are specifically configured to support the presentation of multimedia content on a television or display device other than a computer system's primary display component.

In embodiments of the invention described herein, items of content (e.g., photographs, sound recordings, movie trailers, documents, hyperlinks) are presented in a media ticker. In these embodiments, a media ticker application comprises a user interface configured to display an item's content or an object representing the content.

For example, a photograph or picture may be presented as a thumbnail image; an audio file or multimedia item may be presented as an image identifying the type of content; a document may be presented as an icon indicating the type of document (e.g., word processing, database, spreadsheet). Presented content items may comprise controls for taking some action (e.g., opening an item, playing it, navigating a browser to an associated URL).

In one implementation, content items are grouped into channels comprising items having a common theme, topic, source, publisher or other characteristic. Each channel has one or more publishers—users or organizations that can add content items to the channel and/or remove items from the channel. As described below, a channel publisher or owner may determine who can subscribe to the channel. A user may subscribe to content channels in multiple ways, such as at a channel publisher's website or through the media ticker application.

Illustratively, a user may select and subscribe to any channel she desires unless, as described below, it is restricted in some way (e.g., to invited users, friends of the publisher). Content channels may also be recommended by other users or organizations. Content items to be presented in a user's media ticker may also be specifically selected by the user and added (e.g., dragged) to the ticker, or may be selected by someone else and transmitted to the user's ticker.

In another embodiment of the invention, a computing device, mobile telephone or television is provided for selecting and/or assembling content to be presented to a user, and feeding that content to the user's media ticker or other interface for presentation. The computing device, mobile telephone or television may also be configured to publish content from the user for presentation to other users.

Content may be selected for presentation via a media ticker using a system and/or method described in U.S. patent application Ser. No. 11/115,643, entitled “‘Per User’ Customized and Adaptive Content Delivery” and filed Apr. 26, 2005, which is incorporated herein by reference.

In an embodiment of the invention in which a user experiences media via a media ticker displayed on a television, the extent to which the user can interact with and control the media ticker may depend upon the type of television (e.g., digital or analog), capabilities of the television or television tuner (e.g., Digital Signal Processing, High Definition, input connections (e.g., HDMI, VGA), tuner type), diagonal size, and so on. In this embodiment, the media may be received directly at the television via satellite, a cable network, traditional wireless transmission or other means, or may be displayed on the television after being processed by a satellite receiver, cable tuner, computer system or other device.

Similarly, when a media ticker is presented on a telephone or other device having a relatively small display, manipulation of the ticker may be further constrained by limited modes of operation. For example, a media ticker presented on such a small display may be limited to a single content item at a time. Input controls (e.g., buttons, keys) of the device may allow some manipulation of the ticker during its presentation, or ticker operation may be configured offline (e.g., via a computing device).

Finally, depending upon the device on which the content is displayed, the content may be delivered in real time, or it may be downloaded periodically for viewing at a later date. For example, a television's digital video recorder or a mobile telephone may be programmed to access a channel over the internet and record it so that the user may view that content at a time when the television is not able to access the internet or the mobile phone is not in contact with its network.

A Media Ticker for Presenting Media Content

In one embodiment of the invention, a user interface is provided for presenting media content to a user, along with methods of configuring, operating and interacting with the interface. In one implementation, the user interface comprises a media ticker designed to present content items with little or no action required by the user, thereby allowing the user to passively enjoy content of multiple types (e.g., visual, audio, multimedia) from various sources. As described above, the media ticker may be presented on any suitable display device (e.g., a computer display, a television, a portable or handheld device).

In this embodiment, items of content are presented at one end of the ticker, then scroll, slide or otherwise move across the ticker and disappear at the other end. A content ticker may be positioned horizontally to stream items side-to-side, or vertically to stream them top-to-bottom or bottom-to-top. The content thus appears as a stream of photographs, images, documents, sound files or other items, and may be fast-forwarded, rewound, paused, stopped, started and otherwise manipulated as described below. The ticker itself may also be manipulated (e.g., to resize it, move it, change its appearance).

In different embodiments of the invention, individual items may retain their size, shape, color and/or other attributes as they move through the ticker, or may expand or shrink in size, rotate, change color or other attribute, etc. An item need not transit the entire ticker; that is, it may appear partway through the ticker and transit the remainder, or may be removed partway through the ticker.

Although embodiments of the invention are described herein as presenting content items within a media ticker, it should be understood that the media ticker may present an actual content item or just a representation of an item, depending on the type of item. For example, an item comprising static visual content (e.g., a photograph, a web page, a drawing) may be presented in its entirety or, depending on the size of the ticker and the item, may be resized or otherwise manipulated to fit within the ticker. Motion video (e.g., a movie, an outtake, a trailer) may be represented by a key frame, a screen shot, a thumbnail of a scene or frame, etc.

An item comprising audio content may be presented as an icon or image indicating the type of content, and references herein to presenting and scrolling such a content item may refer to the presentation and movement of the representational image. For example, an image representing audio content may indicate the type of content with an icon (e.g., a speaker icon), identify the name of the corresponding audio file or the type of file (e.g., .wav, .mp3, .mpg), identify a program that can play the content, identify a publisher or source of the content item, etc.

Similarly, other types of content (e.g., multimedia, data files, documents) may be “presented” in a media ticker as images, icons or other objects representing the content. Thus, references herein to the presentation of a content item in a media ticker are understood to refer to the display or rendering of the item's actual content (or a modified version of the content) and/or a simulacrum or representation of the content.

Content items presented in the ticker may be individually (and/or collectively) manipulated or selected for further interaction. For example, if a cursor is positioned over (or clicked on or otherwise used to select) a content item presented in the ticker, the item may be expanded (e.g., if it comprises visual content), may be played (e.g., if it comprises audio content, animation or other moving video), or may be manipulated in some other fashion (e.g., an application may be executed to open the item for playback or editing).

In one embodiment of the invention, items comprising visual content are presented within the ticker and then move within the ticker to allow continued viewing. When an item comprising audio or multimedia content is presented, the content may be automatically played, during which the movement or scrolling of visual content items may or may not pause. For multimedia content, a separate (e.g., expanded) window may be opened for playing the content, or the content may be played in the body of the ticker. After the audio or multimedia content is played, that content item may disappear from the ticker or scroll through the ticker (e.g., and be replayed if selected).

As described above, content items may be grouped into channels for purposes of selection and/or presentation. Content items within a channel may be presented sequentially, randomly and/or interleaved with content of other channels.

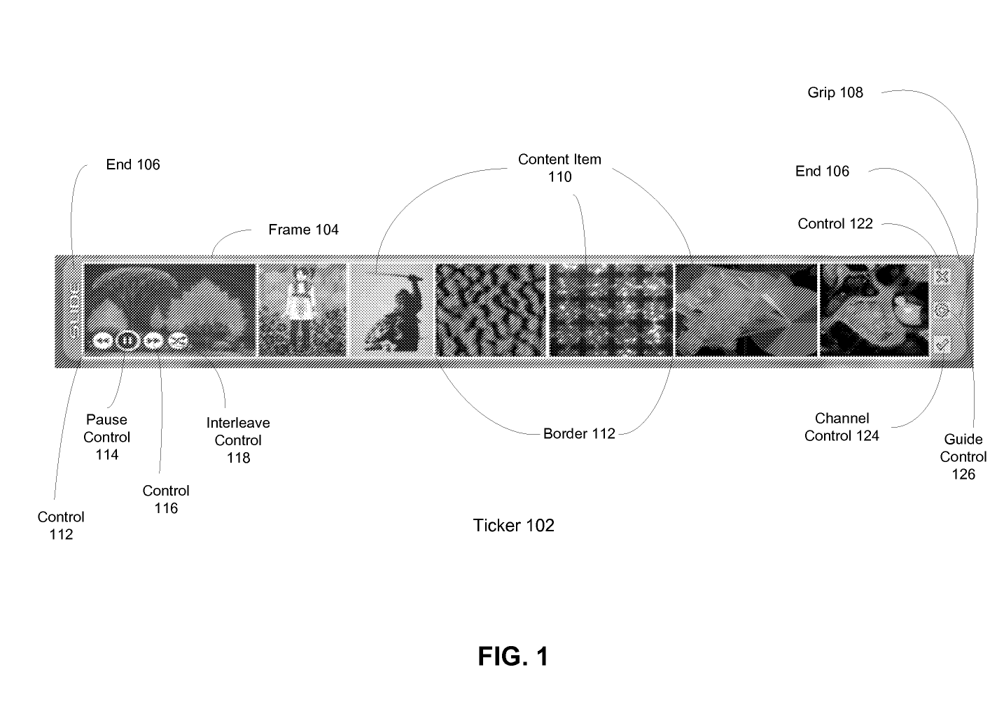

FIG. 1 illustrates a media ticker for presenting content to a user, according to one embodiment of the invention. Ticker 102 is shown as it may appear when implemented on a personal computer executing a common operating system such as Microsoft Windows. A media ticker may appear similarly or differently on other computing platforms and operating systems and/or other types of devices (e.g., a television, a telephone).

In this embodiment of the invention, media ticker 102 is aligned horizontally and comprises a rectangular frame 104 having ends 106. The ticker may be moved (e.g., dragged) to virtually any position on a display device, and may be resizable. If resized, some or all presented content items may be expanded or contracted in size accordingly.

In other embodiments of the invention, a media ticker presented in a two-dimensional display device may take the shape of a circle, semi-circle or virtually any other two-dimensional shape. Depending on the capability of the display device, a media ticker may be displayed as a manipulable object, thereby allowing it to be rotated, repositioned, etc. A media ticker may alternatively be called a “slide” or a “media slide.”

Clicking (e.g., and holding) on a part of frame 104 (e.g., an end 106) allows the ticker to be dragged to a different location on a display device. Illustratively, if the ticker is dragged to an edge of the display area, it may automatically take on a particular (e.g., “maximized”) size in one or more dimensions to match the length (or height) of that edge. In addition, icons, application windows or other objects formerly positioned within the area now occupied by maximized ticker 102 may be automatically resized and/or moved to avoid overlapping the ticker or to decrease any overlap. For example, if a word processing, spreadsheet or other application program currently has an open window that extends to (or near) the display edge, that window may be resized.

Further, if a new application window or other object is opened or created, it may be prevented from overlaying maximized ticker 102. Similarly, other content on a web page displaying a ticker or video presented on a television screen may be moved, resized or overlaid to accommodate changes in the content displayed by the ticker (e.g. presenting the video in a “letter box” format so the ticker can be displayed above or below the letterbox).

When the maximized ticker is later minimized, resized or moved away from the edge, display objects that had been resized or moved may be returned to their original orientation.

In one implementation, an end 106 of ticker 102 of FIG. 1 includes grip 108 for facilitating the resizing of the ticker. Illustratively, clicking on the grip and dragging allows the ticker to be extended or retracted. The ticker may have a minimum width or length (e.g., sufficient to display one content item) and/or a maximum width or length (e.g., the width or height of the display area).

In one embodiment of the invention, ticker 102 may be re-oriented (e.g., from horizontal to vertical) or resized by double-clicking grip 108 (or some other part of frame 104), activating a corresponding control or taking some other action (e.g., manually reshaping the frame by clicking and dragging part of frame 104).

Any number of content items 110 may be presented in the body of the ticker at one time. Ticker 102 is necessarily portrayed as static in FIG. 1, but during normal operation content items will scroll from one end 106 to the other, in either direction. The speed with which content items move from one end 106 to the other may be set by default, but may be configurable by a user.

As shown in FIG. 1, content items may be separated by borders 112. When a content item is selected (e.g., moused-over, clicked), the item's borders may change color or size to show that the item has been selected. For example, an additional inner border may be outlined within borders 112. Then, as described below, the selected item may expand in size or be opened. Item borders and/or other elements of a ticker may change appearance for other reasons also.

Controls for ticker 102 may be arranged on frame 104 (e.g., at ends 106), may be superimposed on the body of the ticker, may be placed near the ticker and/or may be placed elsewhere (e.g., in a drop-down menu, with an icon in a system tray). In the illustrated embodiment of the invention, controls 112-118 affect the presentation of content items 110 within ticker 102, and controls 122-126 perform other functions. Any or all controls described herein may have keyboard equivalents or may be accessible in other ways (e.g., via drop-down menus).

In this embodiment, control 112 enables a user to fast-forward the presentation of content items if the items are scrolling from right to left, or rewind them if they are moving left to right. Conversely, control 116 fast-forwards or rewinds content items moving left to right or right to left, respectively. Another control or command may reverse the direction in which items scroll. If ticker 102 is aligned vertically, controls 112, 116 will operate similarly to fast-forward or rewind content items upward or downward.

Pause control 114 allows a user to pause the presentation by stopping the scrolling of content items. Shuffle or interleave control 118 enables a user to toggle the shuffling or interleaving of content items. In one implementation, when shuffling is turned on, content items from multiple active channels are automatically interleaved, in a random or set manner. That is, a random number of items from one random channel may be presented, followed by a random number of items from another random channel, etc. As a result, content items from any active channel may be presented in any order.

With shuffling turned off, a default or selectable number of content items (or all items) from one channel may be presented before items from another channel are presented.

In other implementations, content items may be presented in virtually any order. For example, X content items from channel 1 may be presented, followed by Y items from channel 2, then Z items from channel 3, items may be randomly presented from all three channels, etc. The quantity and order in which content items are presented from active channels may be preset, may be programmed by a user, or any number of presentation patterns may be offered to the user for his or her selection. An apparatus for controlling the presentation of content via ticker 102, or the computing device on which ticker 102 is displayed, may include a content mixer for determining the order of presentation of content items from multiple channels.

Minimize control 122 enables a user to minimize ticker 102. In the illustrated embodiment of the invention, when minimized, ticker 102 may disappear from the desktop area of the display or from the video screen of the television or mobile telephone, in which case an icon for reactivating the ticker may be maintained in the system tray, an operating system taskbar or elsewhere.

Channel control 124 is activated to open a channel menu. In one implementation, the menu includes a list of some or all channels to which a user subscribes or otherwise has access to. Via this menu, a user can quickly activate or deactivate a particular channel (or group of channels).

Guide control 126, when activated, opens a local content or media guide. As described below, a media guide enables a user to select content channels and/or specific content items to be presented via ticker 102, share channels and/or content with other users, view other users' profiles, etc.

Other controls (not depicted in FIG. 1) may be provided for taking other action. For example, a programmable control may be provided to initiate some user-selected action such as resizing or re-orienting the ticker to a preferred size, position or orientation, changing the rate at which content items scroll, activating or deactivating a particular channel (or channels), activating or deactivating all channels except a particular channel (or channels), etc.

A content item presented in ticker 102 may have various possible behaviors associated with it, depending on the type of content, and can be interacted with separately from other content items. Thus, placing a cursor over (or clicking on) an item may initiate a default action. For example, in FIG. 1, content items 110 are photographs or images, and mousing-over an item may cause the item to expand in size. Mousing-over a different type of content may automatically play or open the content.

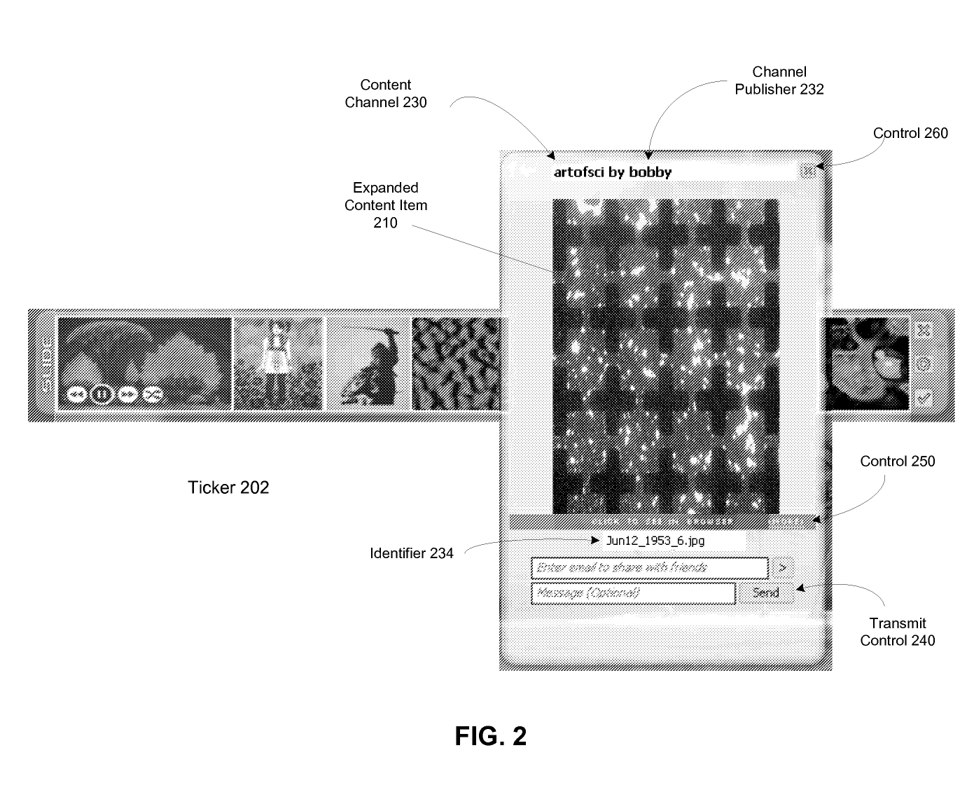

FIG. 2 depicts ticker 202 as it may appear when a content item 210 is moused-over and expanded. Illustratively, the content item is expanded from its position in the ticker body. Expanded content item 210 may therefore overlay ticker 202, and may be displayed with various metadata. The expanded view of the selected content item may or may not comprise a full-size version of the content.

In FIG. 2, expanded content item 210 is presented in a frame that identifies content channel 230 to which the item belongs, channel publisher 232 (i.e., the publisher, provider or owner of the channel) and identifier 234 of the content item. An item identifier may comprise a title, a filename, a description, etc. Various other metadata may also be displayed, such as a measure of the popularity of the content item, a link to related or similar content items (e.g., items depicting the same person or subject, items in the same channel or from the same publisher), etc.

In the embodiment of the invention depicted in FIG. 2, expanded content item 210 is clickable and, when clicked, a browser or other application is opened to display or access the content item. For a visual image such as item 210, a browser window may open to a web page of the channel publisher, to display the content item. Alternatively, an application may be opened to edit the item, provide a full-size view or otherwise manipulate the image. For a content item comprising audio, animation or other multimedia, a suitable application may be opened and the content may be played. In other embodiments, clicking on a content action may initiate other activity.

Expanded content item 210 may be accompanied by controls for initiating various actions. For example, transmit control 240 allows a viewer to transmit the item to another user's media ticker through a media ticker network or send it to someone via electronic mail or other means. Illustratively, text boxes are provided for inputting an identifier (e.g., username, electronic mail address) of the destination user and a message, if desired. A control may be provided for accessing an address book or list of contacts; selecting a user from the list may automatically enter that user's identifier. A “send” control is provided to initiate transmission of the item.

Control 250, entitled “MORE” in FIG. 2, may provide access to additional behavior regarding expanded content item 210. For example, activating control 250 may open a menu or list of links or controls for taking action such as adding content item 210 to another content channel, removing the content item from ticker 202 or content channel 230, saving the item to disk or other storage, etc. Illustratively, a user may only be able to remove content items from channels he or she publishes or has access rights to. Alternatively, a user may be able to prevent content items of other publisher's channels from being displayed in the user's ticker without actually removing the items from the channel.

Expanded content item 210 may be presented as a discrete object, thereby allowing it to be repositioned and/or further resized on the display device. In particular, content items displayed in a ticker may be tearable, meaning that they can be selected and moved (e.g., dragged) or copied out of the ticker. An item may, therefore, be moved somewhere else in a display area or on a desktop, stored in a folder or directory, saved to a computer's hard drive, a mobile telephone's memory or a television's digital video recorder (DVR), etc.

Illustratively, however, the item is not actually removed from the ticker. Instead, a copy of the item is generated, and may be expanded or enlarged. If expanded content item 210 is moved to a folder or other storage area, the item may be stored with or without the frame and controls that accompany the expanded item.

Similarly, in one embodiment of the invention, a content item (e.g., an image file, a sound recording, a document, a URL or hyperlink) may be dragged from a folder, desktop or other area to ticker 202. That item is then scrolled in the ticker and may be added to a default or specified content channel. The item may also be fully functional, meaning that it can be expanded and transmitted to another user via transmit control 240, and may otherwise be manipulated as described above in relation to expanded content item 210.

Control 260 is provided to close expanded content item 210. The scrolling of content items in ticker 202 may or may not automatically pause when content item 210 is expanded. If automatically paused, scrolling may resume when expanded item 210 is closed, and may also automatically resume if the expanded content item is moved from its initial position.

Content items displayed in a ticker may have individualized behaviors associated with them. In other words, a content item may be accompanied by controls for performing actions not available with other items. Such individualized behavior may be specified by the publisher of the content item or may be enabled by a provider of the media ticker.

Thus, an audio file may be accompanied by a control for playing the audio, accessing a music video featuring the audio, visiting a website offering the audio for sale, etc. A document may be accompanied by a control for opening a word processing program, spell-checking the document, saving or printing the document, etc.

In one embodiment of the invention, a media ticker may have multiple modes of operation. For example, in a first mode a ticker may behave as described above, wherein a content item (or a representation of a content item) appears at an initial position in the ticker then moves to a final position and is removed from the ticker.

In an illustrative second mode of operation, however, a content item may be automatically played, expanded, enlarged or manipulated in some other way before it is removed from the ticker. For example, some time after it appears in the ticker and before it is removed from the ticker, a content item may obtain focus (i.e., become the “current” item) and be displayed in full size (or some other size larger than the size with which it moves in the ticker).

After some period of time, the enlarged view disappears and the item continues moving to its final position, if not already there (and another item may be enlarged). The enlarged view may or may not overlap the ticker. Thus, in this second mode of operation, after the mode is activated (e.g., by a user's selection of an appropriate control), all or some content items (e.g., just items of a certain type or in a certain channel) are automatically displayed with a size, position or other appearance different from their appearance while moving within the ticker.

In one embodiment of the invention, content items may be ratable, meaning that a user can express an opinion regarding how enjoyable the items are. This opinion may be used to determine how to sequence content items for presentation or whether or not to present a particular item, may be used to make suggestions regarding other content channels the user may be interested in, etc.

Returning now to FIG. 1, when ticker 102 is minimized (e.g., using control 122), the ticker may continue to operate as a background process, to facilitate a user's selection and/or de-selection of content for presentation. For example, the ticker may be represented by an icon in the system tray (of the Windows operating system) or a taskbar. Selecting (e.g., right-clicking) the icon may provide the user with options such as exiting the ticker program, activating the ticker, opening a media guide (described below), accessing a user profile or account settings, etc.

In one embodiment of the invention, every content item displayed in a ticker belongs to a content channel. Channels may be published by users, commercial organizations, content providers and virtually any other entity wishing to provide content to one or more users. A ticker user may subscribe to any number of channels, depending on which channels are available to him or her.

In this embodiment, a channel is considered public if the publisher allows any user to subscribe. Instead of being public, a channel may be private or semi-private. A private channel may be restricted to the owner or publisher; other users may be able subscribe only if they are specifically invited by the publisher.

A semi-private channel is a channel that is also not available for public subscription, but can be subscribed to by any user selected by the publisher, without a specific invitation. For example, a channel publisher can identify a collection of other users considered friends, relatives, associates, coworkers, etc. Users in that collection may be able to subscribe to any semi-private channel offered by the publisher. Multiple collections of users may be established, with different collections having access to different semi-private channels.

Illustratively, a subscriber to a private or semi-private channel cannot re-publish the channel or invite other users to subscribe to the channel.

A content channel may be collaborative, meaning that more than one user is permitted to add content items to it, remove content items from it, or otherwise customize or edit items within it. Each collaborating user may be considered a publisher of the channel. In contrast, a non-collaborative channel is “owned” by a single publisher, and other users may not be able to add items to the channel, but may be able to remove or prevent selected items from being displayed in their own ticker.

When a user activates a ticker, it automatically begins presenting content items from all active content channels—channels to which the user subscribes and which have been turned on by the user. As described above, a ticker control (e.g., control 124 of FIG. 1) may be provided to allow a user to quickly access a list of all channels to which he or she is subscribed. Selecting a channel in the list may automatically toggle it on or off.

In one embodiment of the invention, a media guide is provided to facilitate a user's subscription to content channels, activation of channels (e.g., to turn them on or off), creation or publishing of channels, etc. A media guide control (e.g., control 126 of FIG. 1) may be provided on a ticker to provide easy access to the guide.

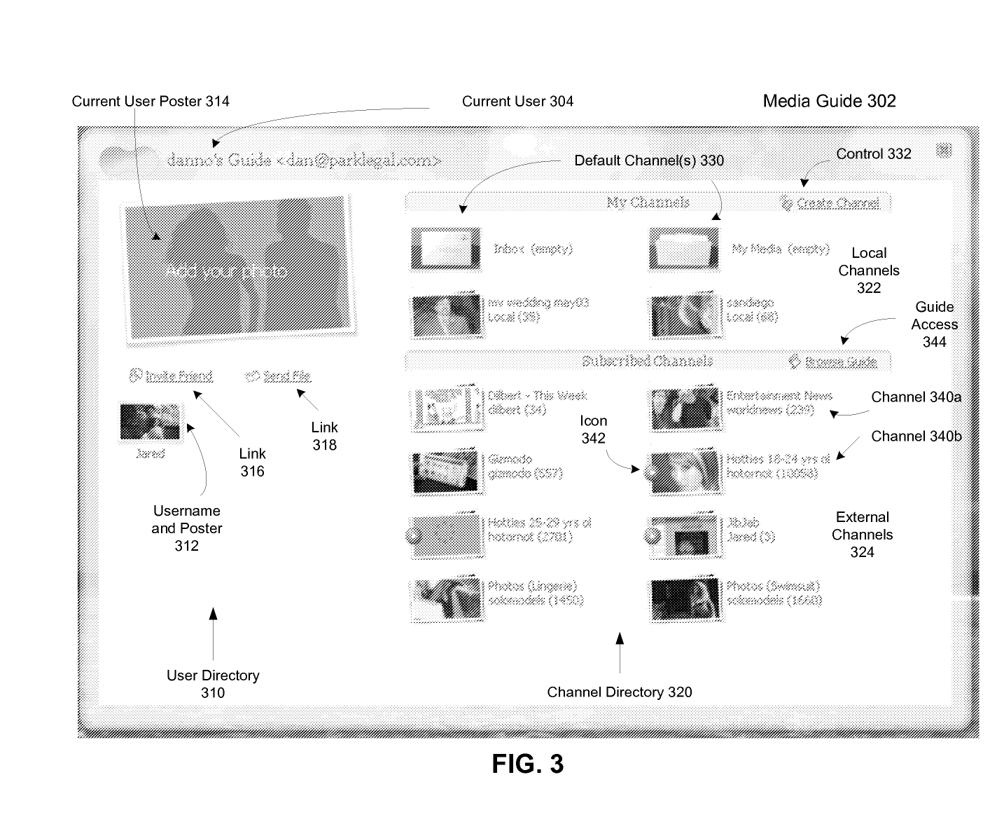

FIG. 3 depicts a local media guide according to one embodiment of the invention. Local media guide 302 of FIG. 3 allows a user to create and modify content channels, manage his or her channel subscriptions, communicate with other users, access a central media guide maintained by the provider of the user's media ticker or some other entity, and take other action regarding the presentation of media content via the user's ticker. When media guide 302 is opened, the current user is identified by user information 304 (e.g., username, electronic mail address).

In this embodiment of the invention, a user's local media guide has two primary focuses: users and content channels. The left side of the illustrated guide comprises user directory 310, identifying other media ticker users. The right side of the illustrated guide comprises channel directory 320.

Channel directory 320 in FIG. 3 contains two groups of channels: local channels (or “My Channels”) 322 and external or remote channels (e.g., “Subscribed Channels”) 324. Other embodiments of the invention may group or list channels in different ways.

In the illustrated embodiment, local channels 322 comprise content channels published by the current user. These may include channels created and maintained locally (e.g., comprising content items stored locally), and may also include collaborative channels of which the user is a co-publisher. Other media ticker users may be able to subscribe to the current user's local channels, if the current user permits. External channels 324 comprise channels published by other users and organizations.

Channels may be identified or represented with various metadata. For example, for a channel comprising visual content, one of the content items in the channel may be used as a channel poster. Each channel in external channels 324 is accompanied by a channel poster. Channel posters may be optional, but may be used to reflect the type of content in the channel, identify the source of the channel or content, etc.

As exemplified by channel 340a, a channel may also be identified by a name (e.g., “Entertainment News”), a publisher (e.g., “worldnews”), a number of items in the channel (e.g., 239), and/or other information. The publisher of a channel may be identified by the publisher's username within the media ticker network, an organization name or personal name, etc. The publisher of a local channel (e.g., in local channels 322) may be identified as “local” or may be omitted.

One or more default local channels 330 may be included among local channels 322 and/or external channels 324 when a media ticker is installed on a user's computing device or a user's social networking page or other web site. For example, an “Inbox” channel may be a default local channel in which content items are stored when received from another media ticker user. Illustratively, one user may transmit a content item to another user's ticker by dragging the item to the destination user in user directory 310, by manipulating a corresponding control on the item in an expanded view (e.g., transmit control 240 in FIG. 2), and/or in other ways.

Another default local channel (e.g., “My Media”) may be used to store content items added to a user's ticker by that user if no other channel is specified. For example, the user may receive an item via electronic mail (e.g., rather than through her ticker), create a new drawing on her computing device, download a media file from the Internet, etc. The user may then drag the item onto her ticker and it may be automatically stored in this channel. Also, an item may be dragged to a specific local content channel to purposefully place it in that channel.

In one embodiment of the invention, a user may drag a URL (Uniform Resource Locator) or network address (e.g., an IP address) onto a media ticker or a specified content channel folder (e.g., from an address window of a web browser, from a hyperlink). The URL is then added to the specified content channel (or a default channel) and is presented in the ticker. A URL may be represented in the ticker by an appropriate icon, symbol or image. Illustratively, the content item for the URL comprises a link to the specified location, not just a screenshot of the page at the URL.

Any number of other local channels may be created by or for the current user. In one implementation, when a media ticker (and local media guide) is installed on the user's computer system, storage components of the system may be searched for content (e.g., particular file types) and content channels may be automatically created. For example, if a directory of photographs, audio files, movie trailers or other content is found, a channel may be automatically created to contain those items, and may be given a name matching the name of the directory.

In the embodiment of the invention depicted in FIG. 3, local media guide 302 includes control 332 for facilitating a user's creation of a new local content channel.

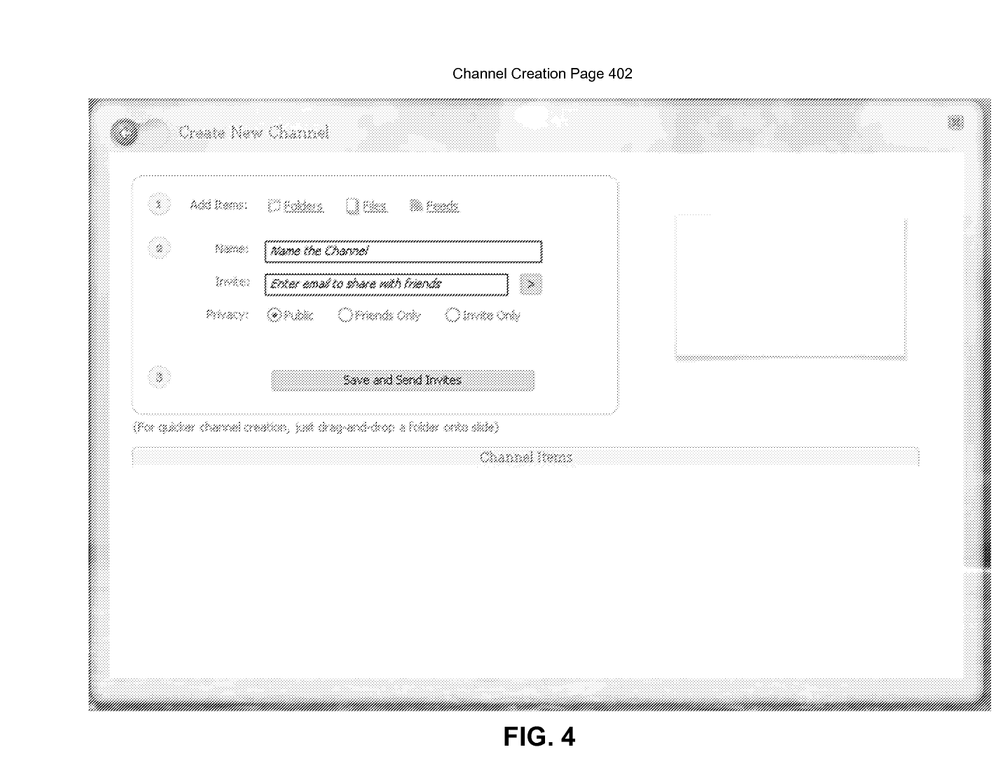

FIG. 4 demonstrates channel creation page 402 presented to the user when he activates control 332, according to one embodiment of the invention. In this page, the user may add folders of content items, individual content items (e.g., files), media feeds and/or other collections of content items to the new channel. Selecting the “Folders” or “Files” option opens a dialog box allowing the user to select the folder(s) or file(s) of content items to be added to the channel. Selecting the “Feeds” option opens a dialog box allowing a user to select a content feed (e.g., an RSS (Real Stream System)).

Channel creation page 402 also elicits a name for the channel and allows the user to invite other users to subscribe to the channel. Invitees may be identified by a username known within the media ticker network, an electronic mail address, or some other identifier. In one implementation, content items and/or folders containing content items may simply be dragged onto channel creation page 402 in order to place them in the channel, and/or may be dragged onto the corresponding icon in local media guide 302 after the channel is created.

Within channel creation page 402, the user may set a privacy level for the new channel. For example, a channel may be made public if any or all other media ticker users are allowed to subscribe. Alternatively, a channel may be made semi-private or “friends only” if open subscription is to be limited to a group of users listed in user directory 310 of media guide 302. As another alternative, a channel may be made private or “invite only” to limit subscriptions to specifically invited users. A user may be invited to subscribe to a local channel using an invitation control on channel creation page 402, an invitation control accessed from local media guide 302 (e.g., by right-clicking on the channel) and/or in other ways. Similarly, users may add themselves to a “fan” list for a particular content channel and ask to be added to other channels of the same creator or publisher, whether currently existing or created in the future.

Returning to FIG. 3, external channels 324 identifies external content channels to which the user has subscribed. A user may subscribe to any number of external channels; a scroll bar may be provided to scroll the listing of channels if necessary. In one implementation, external channels may be grouped by publisher, rating, type of content or other characteristic.

Channels listed in channel directory 320 may be marked to indicate which are currently active, that is, which channels are currently selected for presentation in the user's ticker (e.g., which channels are “turned on”). For example, the poster associated with channel 340b is overlaid with a particular icon, icon 342, indicating that it is active, whereas channel 340a is not highlighted with the icon and the current user can easily discern that this channel is not active.

Selecting or clicking on a channel in channel directory 320 may enable or execute miscellaneous activity. For example, left-clicking on a channel may toggle the channel from being active to inactive, and vice versa. Right-clicking may initiate other default action or bring up a menu allowing the user to take some action.

For example, a menu accessed by selecting a channel in channel directory 320 may allow the user to toggle the channel active or inactive, invite another user to subscribe to the channel, delete or unsubscribe from the channel, add or remove a content item to/from the channel, etc.

The current user may be able to take additional action with regard to a local channel. In particular, because the user is the owner or a publisher of the channel, the user may be able to access the channel's contents by clicking (e.g., right-clicking) on the channel or selecting an appropriate menu option.

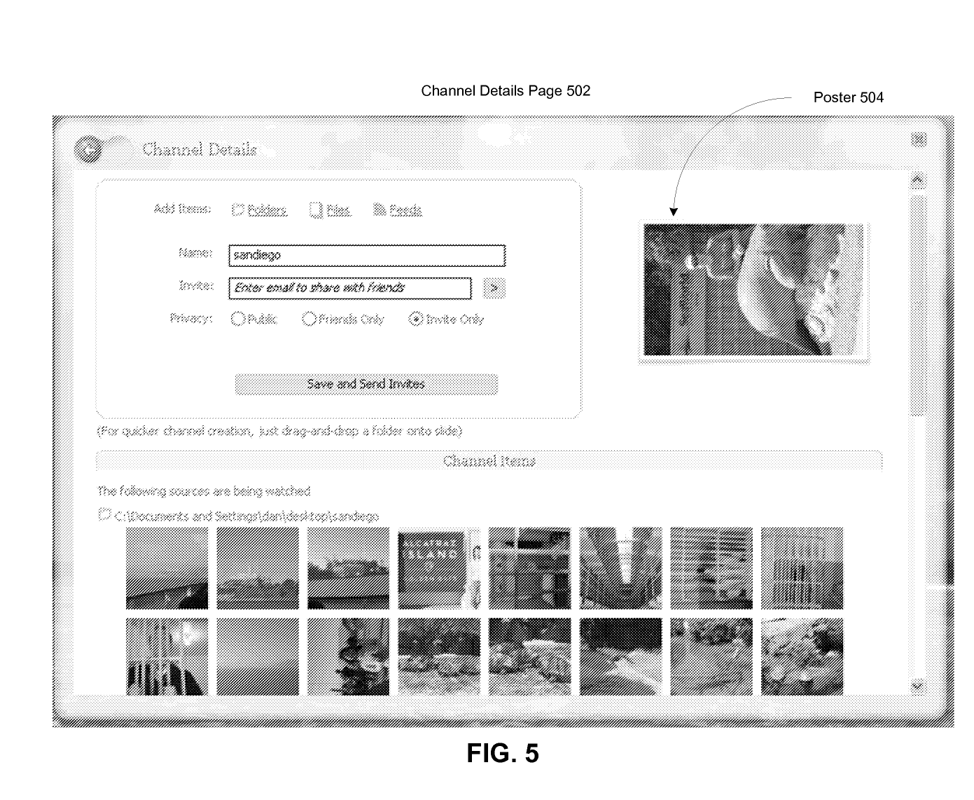

FIG. 5 depicts an illustrative channel details page 502 for a local channel, according to one embodiment of the invention. As described above, this page may be accessed by selecting the local channel or selecting an appropriate option from a menu of options.

Channel details page 502 allows the user to add content items to the channel, similar to channel creation page 402 of FIG. 4. Channel details page 502 also allows a user to select an image to serve as the channel's poster 504. As described above, the poster represents the channel within the user's local media guide 302, and may also represent the channel in the media guides of other users that subscribe to the channel and/or a central media guide identifying channels published by multiple users/organizations. Illustratively, clicking on poster 504 yields a dialog window allowing the user to select a poster image, from within the content channel or some other location.

Channel details page 502 also displays some or all of the content items currently in the channel, particularly graphical items. Non-graphical content items may be represented by appropriate icons or images indicating the type, source or other characteristic of the content. Clicking on an item in channel details page may allow the user to access the content, select it as a channel poster, transmit the item to another user, delete it from the channel, etc.

Returning again to FIG. 3, guide access control 344 of channel directory 320 enables the current user to access a central media guide, which may list content channels the user may subscribe to, identify other media ticker users, allow the user to search for content and/or users, etc.

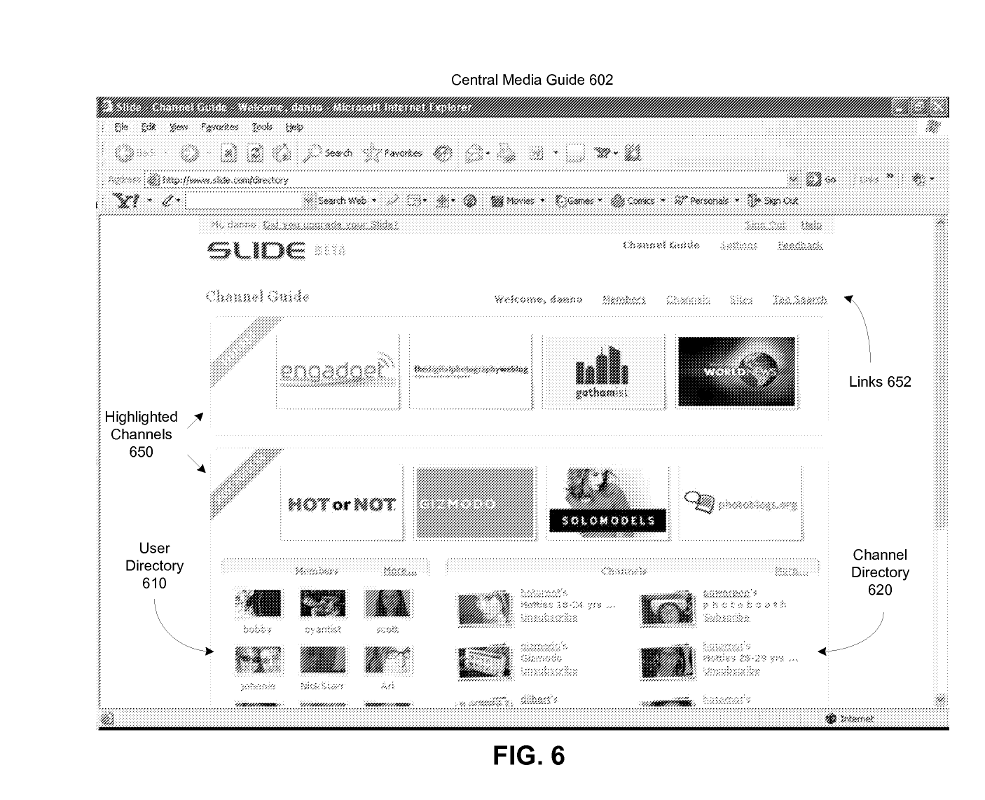

FIG. 6 demonstrates central media guide 602 according to one embodiment of the invention. In this embodiment, central media guide 602 is presented in a web browser, but may be presented in other ways in other embodiments of the invention. For example, in one alternative embodiment, a central media guide may be presented similar to the manner in which (local) media guide 302 is presented—within an application accompanying or comprising a media ticker.

In FIG. 6, central media guide 602 is formatted similar to local media guide 302, in that it includes user directory 610 and channel directory 620. The central guide may also highlight particular channels (e.g., the most popular channels, new channels, featured channels), as indicated by highlighted channels 650, introduce new users, etc.

As with local media guide 302, at central media guide 602 the current user may subscribe to a channel by clicking on it in channel directory 620 or highlighted channels 650, accessing a menu offering a “subscribe” option, or taking other action. Similarly, user information may be accessed by selecting or clicking on a user's poster in user directory 610.

Links 652 within central media guide 602 are provided to enable a user to quickly access a larger directory of users (e.g., members) or content channels, a list or page identifying world-wide web sites offering content items and/or channels, a search page allowing the user to initiate a search for users, items or channels, a web page of an organization that provides or maintains a media ticker application, etc.

Other links may be provided to allow the user to access his or her profile, submit feedback to a provider of a media ticker, obtain help for using a media ticker or media guide, etc.

Returning now to media guide 302 of FIG. 3, user directory 310 lists other ticker users that have been added by the current user or that have some relationship with the current user.

In user directory 310, a user is identified by a username and/or poster, as shown for user 312. As described above, a poster may comprise a thumbnail photograph or other image or graphic. A user poster may, for example, comprise a photograph identifying or corresponding to the user. Each user may select his or her own poster. The current user's poster is displayed as poster 314. Clicking on poster 314 may allow the current user to select his or her poster (e.g., by navigating to a desired content item).

Illustratively, a user may be added to user directory 310 by entering his or her username in a dialog box, by inviting him or her to join, by sending the user a content item or channel, etc. For example, in media guide 302, link 316 (e.g., “Invite Friend”) is provided to invite someone to obtain a media ticker (if he or is not already a media ticker user). Inviting someone may automatically add them to user directory 310. In addition, a user may be automatically added to user directory 310 if the current user accepts a content item from the user, subscribes to a channel published by the user, sends a content item or channel subscription invitation to the user, etc.

Link 318 is provided to allow the current user to quickly and easily send an item to another user. Selecting link 318 may open a dialog box allowing the user to locate the desired item. A destination user may then be identified by username, electronic mail address, etc. The item may then be sent via electronic mail or the destination user's media ticker.

When the current user subscribes to a public content channel, the publisher may or may not be automatically added to user directory 310. For example, the current user may only wish to include in the user directory those users who are friends or associates (e.g., users that are allowed to subscribe to the current user's semi-private or “Friends Only” content channels).

Mousing-over a user in the user directory may yield further information regarding the user, such as electronic mail address, name, etc. Selecting (e.g., clicking on) a user in user directory 310 may open a web browser or other application for viewing the user's profile. In one implementation, the selected user's profile may be opened within or overlay media guide 302. User profiles may be maintained at a central site (e.g., an organization that provides a media ticker), local to the users, or elsewhere. For example, and as described above, links to all users and/or their profiles may be accessible at a central media guide accessed via guide access 344.

A user profile may be substantially similar in appearance to media guide 302, but be personalized to that particular user. For example, a user's profile may display that user's user directory 310 and channel directory 320.

The current user may subscribe to some or all channels identified in another user's user profile. For example, the current user may be able to subscribe to any public channels listed in the other user's profile, but may only be able to request subscription to a private or semi-private channel. In one implementation, a current user may subscribe to a semi-private channel (e.g., a “Friends Only” channel) of a target user if the current user is included in the target user's user directory 310.

A user's entry in user directory 310 may be used as a means to transmit data to the corresponding user. In particular, by dragging a document, image or other file onto the entry, that object may be automatically transmitted to the user's ticker. In one implementation, the object is added to a default content channel (e.g., an “Inbox” channel) at the recipient's ticker. Dragging a content channel from channel directory 320 onto a user in user directory 310 may issue an invitation to the recipient to subscribe to the channel.

When a specific content item sent from one user to another user is received at the recipient's media ticker, it may be initially presented as a normal item. That is, it (or an icon or other object representing the item) may be displayed at one end of the ticker, then scroll to the other end. In one embodiment of the invention, however, the item may stick at one end or the other until acknowledged or manipulated by the recipient.

As described above, the content item may be placed in a default local channel of the recipient (e.g., an “Inbox” channel). When presented in the ticker, however, the recipient may select the item and save it into a different channel, delete it, tear it out of the ticker to a folder, directory or desktop, open an application to access the item, etc.

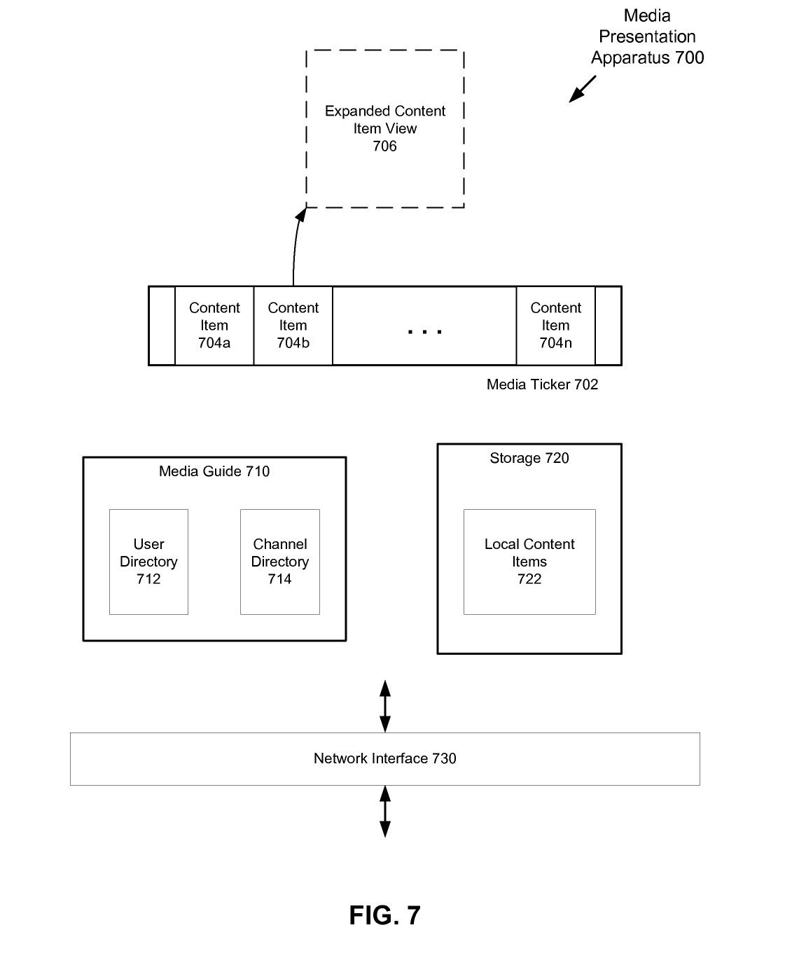

FIG. 7 is a block diagram depicting components of an apparatus for presenting media content to a user through a media ticker, according to one embodiment of the invention. The apparatus may comprise a computer system or other type of computing device having a display in which the ticker can be rendered.

In the illustrated embodiment, media presentation apparatus 700 includes media ticker 702 for presenting content items to a user on a display device. The ticker may display (e.g., scroll) any number and type of content items 704, depending on how many content channels are active, how many content items are included in the active channels, the type of content contained in an item, the current scheme for interleaving items from different channels, etc.

Visual content items may be represented in ticker 702 as smaller versions of the items (e.g., thumbnails), or full size images if ticker 702 is large enough. Non-visual content items may be represented by appropriate icons, images or other objects.

A content item may be enlarged and presented in expanded content item view 706 if a user expresses an interest in the item (e.g., by mousing-over the item in ticker 702). While content items may scroll or move in some other fashion in ticker 702, an enlarged view of a content item may persist for a longer period of time. For example, it may stay open until the user expressly closes it or takes some decisive action (e.g., to store it in a folder, save it in a different content channel).

Media guide 710 may be displayed when a user activates a control on ticker 702, manipulates a media ticker icon in a system tray or taskbar, or takes some other action. The media guide includes user directory 712 identifying users associated with a current user, and channel directory 714 identifying content channels owned or published by the current user and/or channels to which the user has subscribed.

Storage 720 stores any number of content items, and may comprise magnetic, optical and/or other types of storage devices that may be mechanical or solid-state. In one embodiment of the invention, only content items of local content channels (e.g., channels created, published or maintained by the current user) are stored on storage 720. Content items received from other content channels may be stored only in transient fashion (e.g., in volatile memory) unless or until they are moved to storage 720.

In one alternative embodiment of the invention, content items from non-local channels may be stored on storage 720 for caching purposes, but may be removed if or when the user deactivates the channel, unsubscribes from the channel, or when the items are deleted from the channel by a publisher or owner of the channel.

Network interface 730 comprises a network interface circuit or other communication adapter for accessing a network or communication link through which content items may be received and/or sent. Other computing device components used in the operation of apparatus 700 are omitted from FIG. 7 for clarity; such components may include one or more processors, communication buses, input devices (e.g., mouse, keyboard), output devices (e.g., monitor, printer), etc.

Ticker 702, expanded content item view 706 and media guide 710 may be provided as part of a graphical user interface, operating system, media ticker application or other software executed by a computing device.

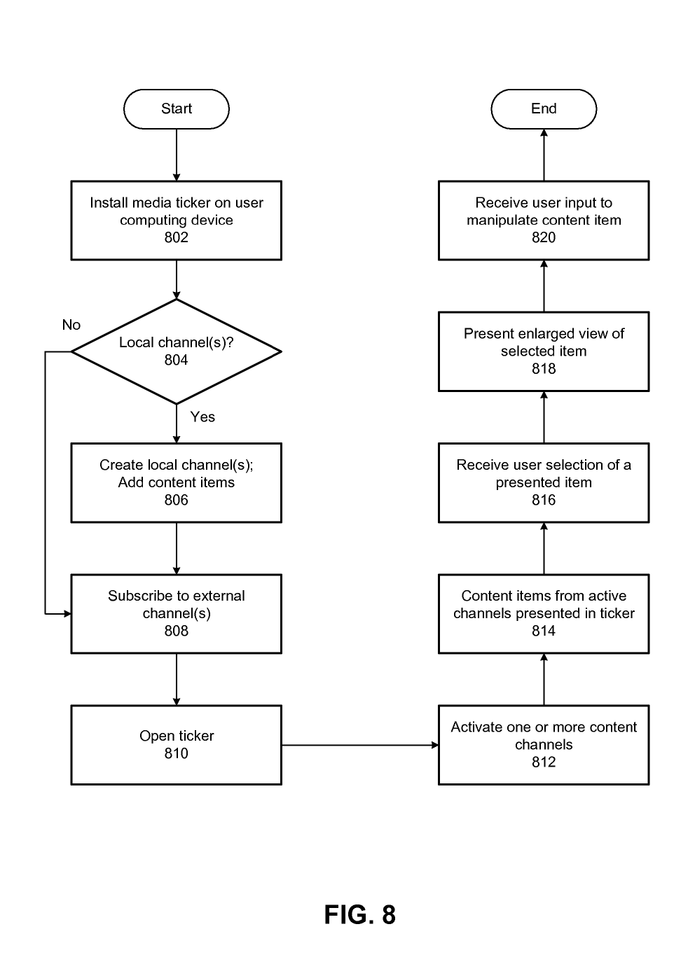

FIG. 8 demonstrates a method of presenting media content to a user via a media ticker, according to one embodiment of the invention. In this embodiment, the media ticker comprises a user interface for displaying content items from any number of content channels and allowing a user to manipulate those items.

In operation 802, media ticker software is installed on the user's computing device. The user may navigate to a media ticker provider website, for example, and download the software. Or, the user may be invited (e.g., by a friend or associate) to join a media ticker network and receive a link to a site from which the software can be obtained. The user may then navigate to that site and allow the software to be installed.

In operation 804, the user may choose to establish one or more local content channels, using content items available at the computing device. Illustratively, a local channel may be automatically established during installation or configuration of the user's media ticker. For example, during the installation process, the user's computing device may be searched for content items. If a local channel is to be established, the method continues with operation 806; otherwise, the method advances to operation 808.

In operation 806, the user may identify a set of content items (e.g., by folder or directory, by file, by type) or approve a set of items located during the software installation process. The content items may include graphical or visual content (e.g., photographs, drawings, images, documents), audio content (e.g., music files, other sound recordings) and/or multimedia or other content (e.g., movie trailers). The user may specify a name for the channel, or a name may be adopted from the directory or location at which the items are stored.

A graphical content item may be selected to be used as a poster to represent the channel; if the content items are not graphical, a default or representative icon or image may be selected to represent the channel. In one implementation of the illustrated embodiment of the invention, a local channel is automatically established during installation of the media ticker, without user interaction.

In operation 808, the user may subscribe to any number of external content channels (i.e., channels not maintained on the user's computing device). Illustratively, the user may access a local or central media guide to identify and subscribe to channels, may visit websites or profiles of people or organizations that publish content channels, may receive and accept an invitation to subscribe to a channel (e.g., a friend's private or semi-private channel), etc.

In operation 810, the user opens the media ticker if it is not already open. The ticker may already be open, for example, if the user created local content channels and/or accessed external channels via his or her local media guide. In one embodiment of the invention, when the media ticker is minimized, it becomes available through a system tray icon but is not placed on an operating system taskbar.

In operation 812, the user activates one or more local and/or external content channels. Channels may be activated or deactivated via a local media guide, through a menu opened by clicking a control on the ticker, and/or in other ways.

In operation 814, content items from the active channels are presented in the media ticker, moving or scrolling from one end to another. In other embodiments of the invention, a media ticker may include a frame or body that is round, oval or some other shape than rectangular. In these other embodiments, content items may move in a non-linear fashion within the ticker.

Visual content items may simply be displayed or rendered when presented. Audio or multimedia content items may be opened and their content played when presented. Any type of content item may be represented in a ticker by an appropriate image or symbol.

In operation 816, the user selects (e.g., mouses-over) a presented content item.

In operation 818, an enlarged or expanded version (e.g., full-size, half-size) of the selected content item is generated and presented outside of (e.g., overlapping, adjacent, separate from) the ticker. Movement of content items in the ticker may pause until the expanded view is closed, is moved so as to not overlap the ticker, or is manipulated in some other fashion.

In operation 820, the user initiates some action with regard to the content item. Illustratively, he may save it into a different content channel. In one implementation, a user may only add content items to local channels. Other actions the user may take include transmitting the item to another user, closing the expanded view, deleting the item from its channel (e.g., if it is a local channel), opening an application program to access (e.g., play, view, edit, rate) the item, etc.

After operation 820, the user may manipulate other content items, activate or deactivate a content channel, or take other action as described above.

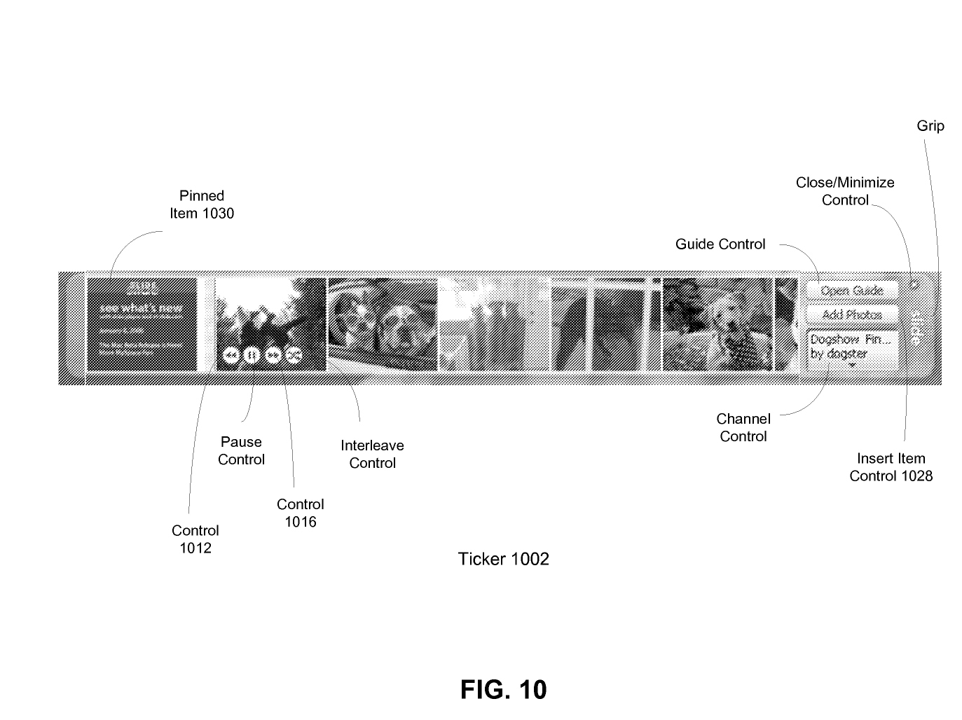

FIGS. 10-18 depict a media ticker and associated components (e.g., media guides) according to an alternative embodiment of the invention. In this alternative embodiment, a “slide show” incorporates any number of content items and is comparable to a content channel described above. Thus, the terms content channel and slide show may be used interchangeably in this alternative embodiment of the invention.

In FIG. 10, ticker 1002 includes controls similar to those depicted in ticker 10 of FIG. 1, such as pause and interleave controls, controls 1012, 1016 for advancing (e.g., fast-forwarding) or rewinding the movement of content items. Ticker 1002 is shaped similar to ticker 102, having two ends, a frame and a body. One of the ends includes a grip for lengthening or shortening the ticker.

Some controls are implemented differently, such as the guide control and channel control, but both still operate in similar fashion. Clicking the guide control opens a media guide, while clicking the channel (or slide show) control opens a list of channels or slide shows a user is subscribed to. From the list, the user can activate or deactivate some or all channels or slide shows, turn interleaving on or off, pause the presentation of content items, etc.

Ticker 1002 includes insert item control 1028, which a user may activate in order to add a content item, a folder of items or a stream of items (e.g., from an RSS feed) to a slide show or the media ticker. Activating the insert item control may open a page similar to item insertion page 1202 of FIG. 12. Via page 1202, the user may select items for insertion, invite other people to enjoy a slide show (e.g., existing media ticker users and/or non-users), and so on. A slide show may comprise some or all content items from another slide show or content channel, a folder or feed of content items or some other collection of items.

Media ticker 1002 of FIG. 110 also demonstrates how a content item may be pinned to a ticker in an embodiment of the invention. Illustratively, pinned item 1030 is stationary at one end of the body of the ticker (e.g., the end at which items disappear) until a user clicks on the item or takes other action (e.g., moves it to a folder, adds it to a slide show). The pinned item may have been received as part of a channel the user is subscribed to (e.g., and was marked in some way by the publisher), or may have been individually dispatched to the user from another media ticker user (e.g., using a transmit control such as control 240 of expanded content item 210 of FIG. 2).

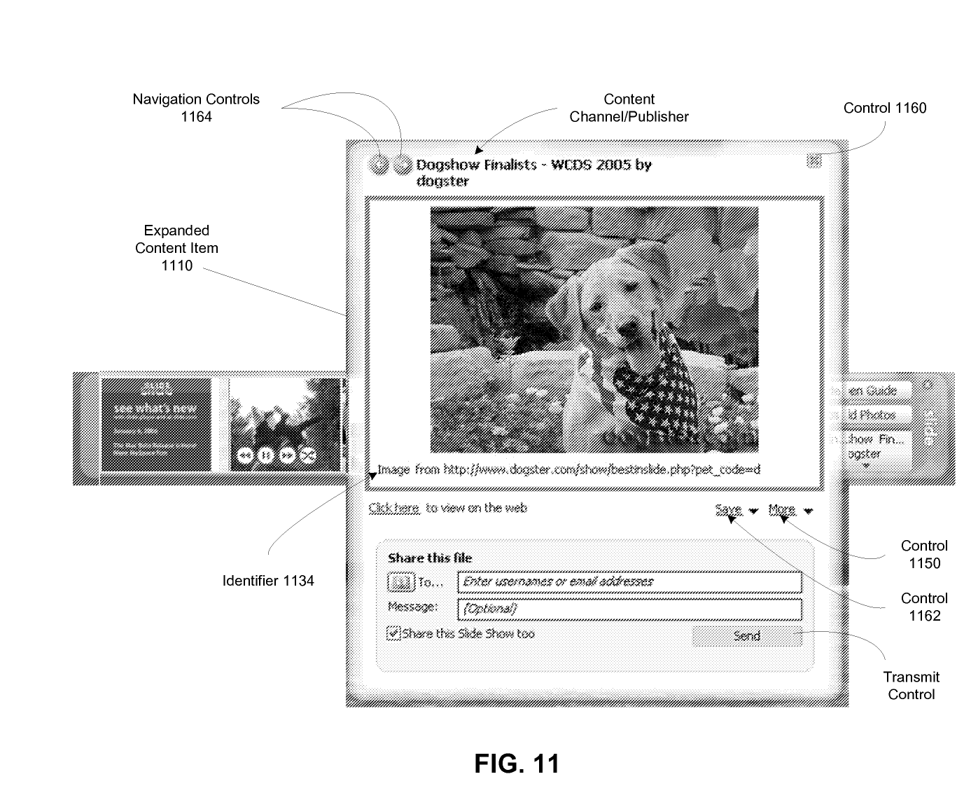

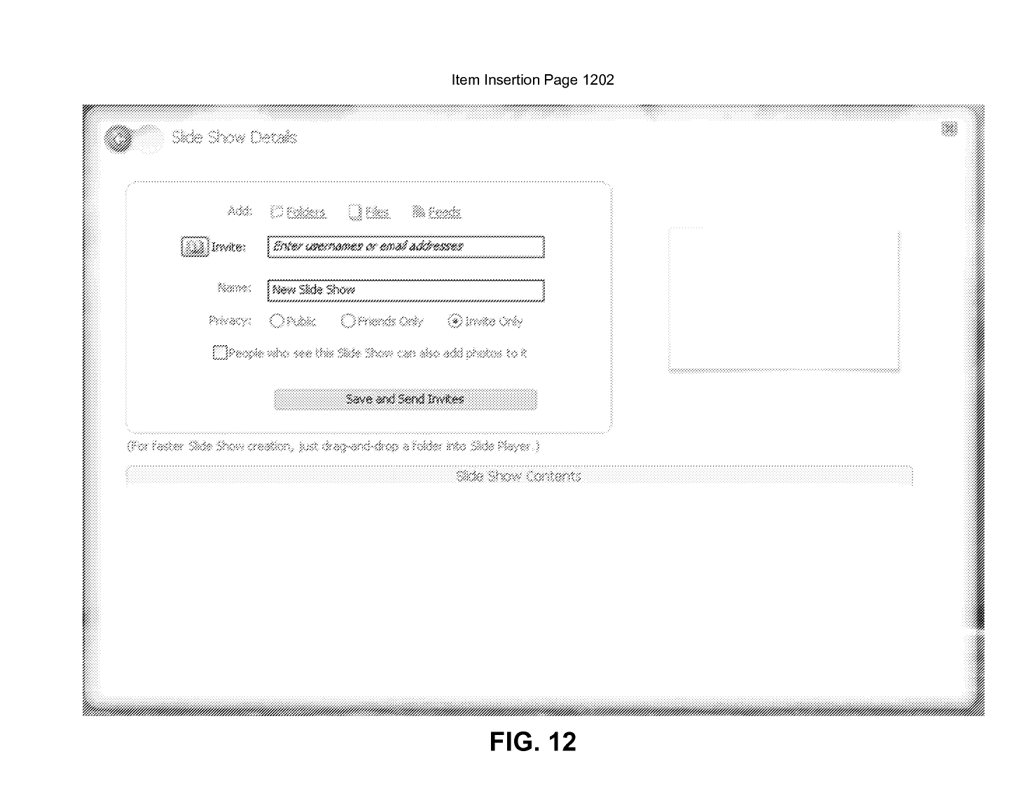

FIG. 11 depicts an alternative form of an expanded content item. Expanded content item 1110 includes channel/publisher information indicating the item's slide show/channel and/or publisher, and identifier 1134 for identifying the specific item (e.g., by URL, filename). A user may click on the item to open it in a browser or other application.

Control 1150 allows a user to access additional behavior, to turn off the slide show containing the item, to turn off all slide shows except the show containing the item, unsubscribe from the slide show, delete the item from the slide show, etc.

Control 1160 allows the user to close the expanded content item. Illustratively, content items may (or may not) stop moving in the media ticker while the expanded content item is open, and may then resume moving when the expanded item is closed. Control 1162 may allow the user to save the content item (e.g., to disk, to a folder, to a desktop, to a slide show). Navigation controls 1164 allow the user to quickly access the next/previous content item in the slide show or the ticker.

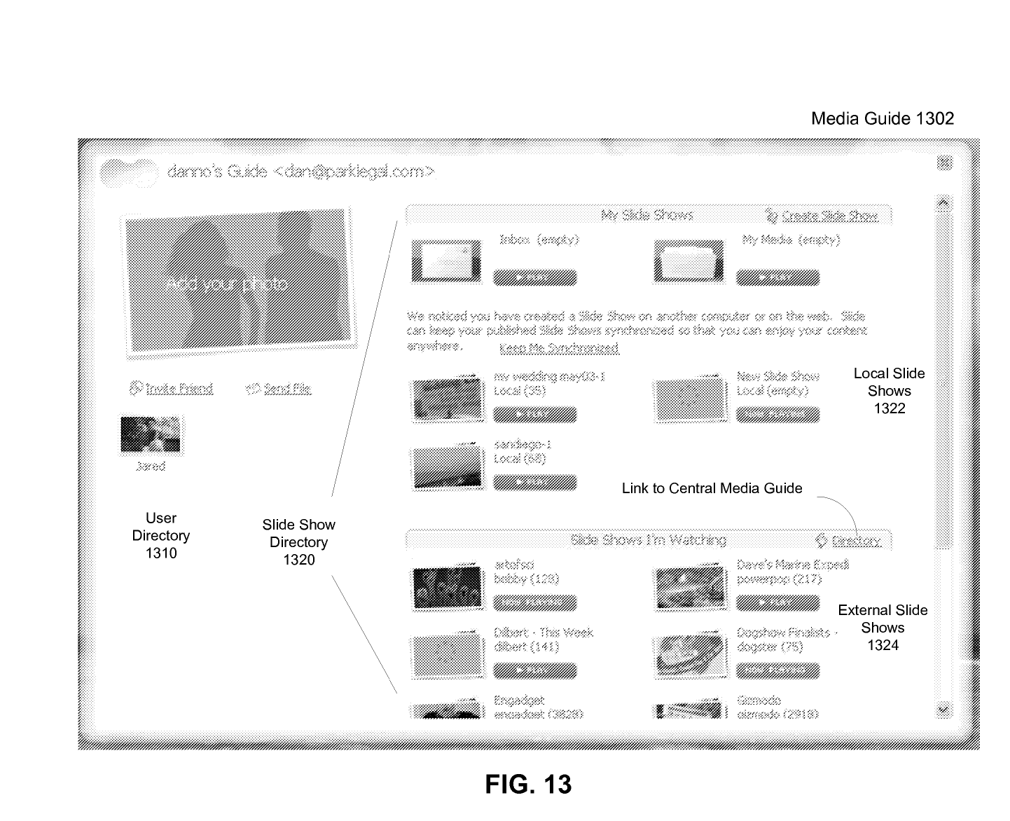

FIG. 13 demonstrates an alternative (local) media guide for a media ticker user. Guide 1302 is similar to media guide 302 of FIG. 3, but refers to channels as slide shows.

Media guide 1302, similar to guide 302 of FIG. 3, is divided into a user directory (i.e., the left side of guide 1302) and a slide show directory (i.e., the right side of guide 1302). The slide show directory portion is divided into the user's local slide shows (i.e., on top) and external slide shows to which the user is subscribed (i.e., on bottom). Other portions may be included in the slide show directory (e.g., slide shows shared with another user).

In slide show directory 1320, each slide show is accompanied by a control that indicates whether the slide show is active (e.g., “Now Playing”) or inactive (e.g., “Play”) and that can be clicked to toggle the show between being active and inactive. Illustratively, right-clicking a slide show's title or poster (or status indicator) allows a user to also toggle the show's status, access additional details (e.g., via a page such as channel details page 502 of FIG. 5), invite someone to share or subscribe to the show, delete the show, etc.

A user's media guide also includes a link to, or control for accessing, a central media guide such as guide 602 of FIG. 6. In media guide 1302, the link is titled “Directory”.

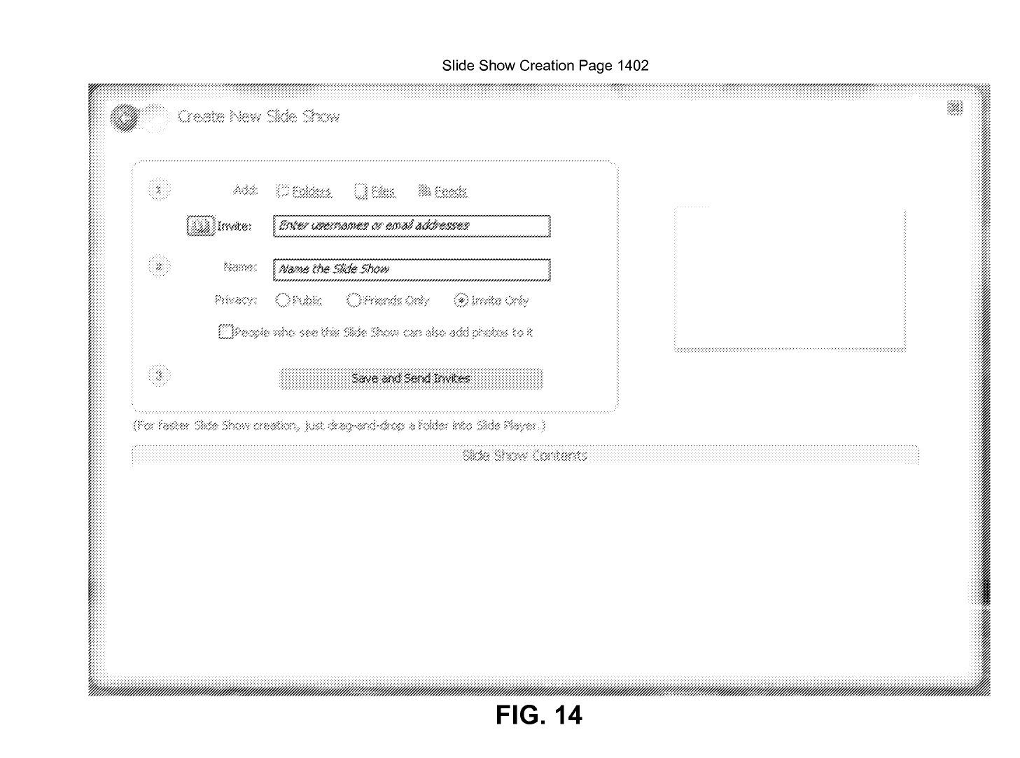

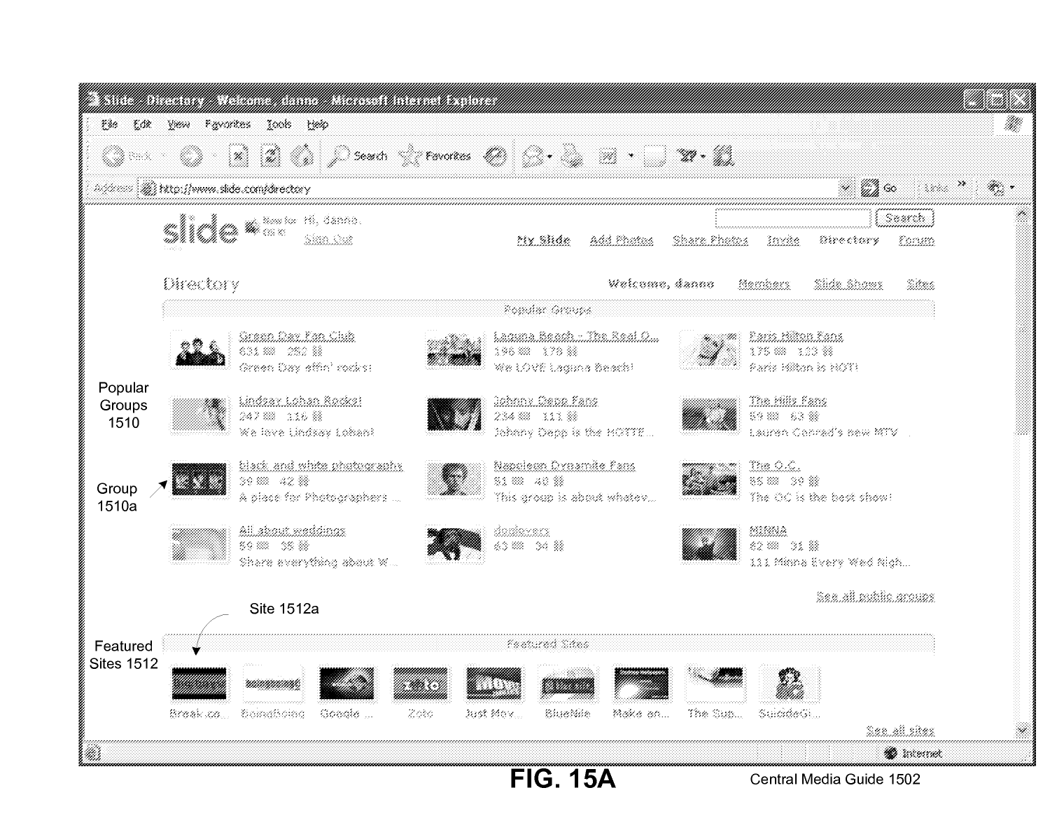

FIG. 14 depicts an alternative page for creating a new slide show, similar to channel creation page 402 of FIG. 4. Slide show creation page 1402 allows a user to select folders of content items, individual items (e.g., files), content item streams or feeds (e.g., RSS feeds) to populate the new slide show. The user identifies any other users or non-users that should be invited to view, subscribe to or share the slide show, and also assigns a name to the show. The user also sets the privacy and may specify whether other viewers can add items to the show.

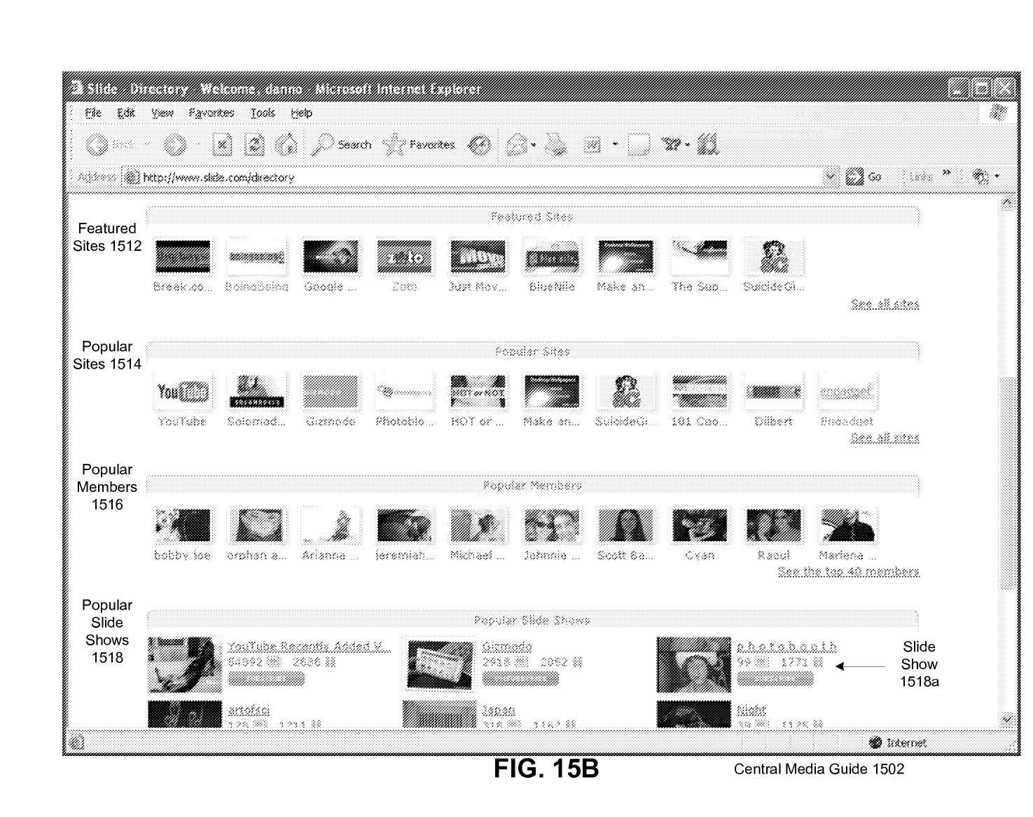

FIGS. 15A-B depict an alternative central media guide (or directory), which allows a user to access slide shows available for subscription or viewing, a central list of other users, discussion boards, etc. In one embodiment of the invention, a user may be able to view his or her media ticker through a central media guide (e.g., while traveling).

FIG. 15A shows a first portion of central media guide 1502; FIG. 15B shows a second portion accessed by scrolling down from the portion shown in FIG. 15A. Central media guide 1502 may also be reachable by navigating a browser to a specified URL or web page (e.g., http://www.slide.com/directory). A user may need to login to the directory if he does not connect via his media ticker or local media guide.

Central media guide 1502 is divided into multiple sections or portions, such as popular groups 1510, featured sites 1512, popular sites 1514, popular members (users) 1516, popular slide shows 1518, etc. The central media guide also includes links to members (i.e., “Members” link), slide shows (i.e., “Slide Shows” link) and sites (i.e., “Sites” link) for accessing members, slide shows and sites (e.g., web sites).

Popular groups 1510 includes groups of media ticker users having a common interest. Each identified group may be accompanied by information such as a name of the group, the number of members or subscribers, a number of messages (e.g., bulletin board posts), a poster reflecting the group's interest, and so on. Clicking a group may take the user to one or more other pages that show content items corresponding to the group, profiles of group members, a discussion board, etc.

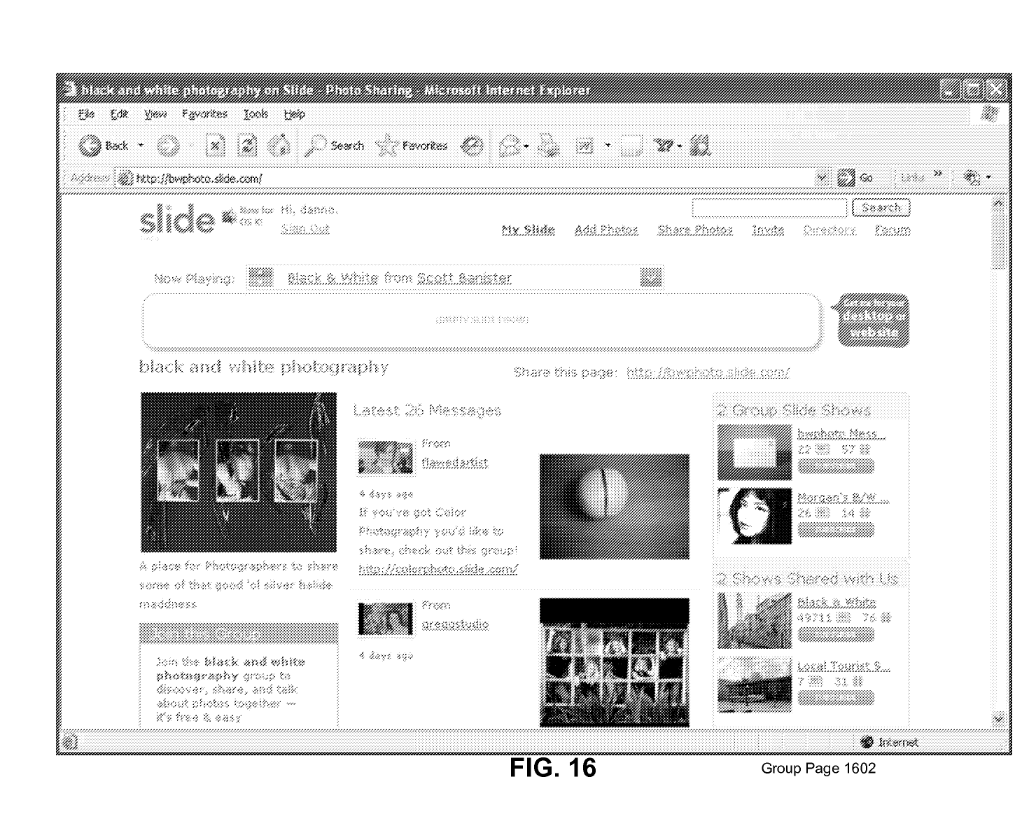

For example, selecting group 1510a presents group page 1602 shown in FIG. 16. Group page 1602 presents one or more slide shows (if any have been assembled for the group), along with links for adding content items, inviting a user (or non-user) to access the group, etc. Messages from group members are also displayed; a message may include a content item, the member's poster, and/or other information. Group page 1602 may be considered a guide page for the selected group.

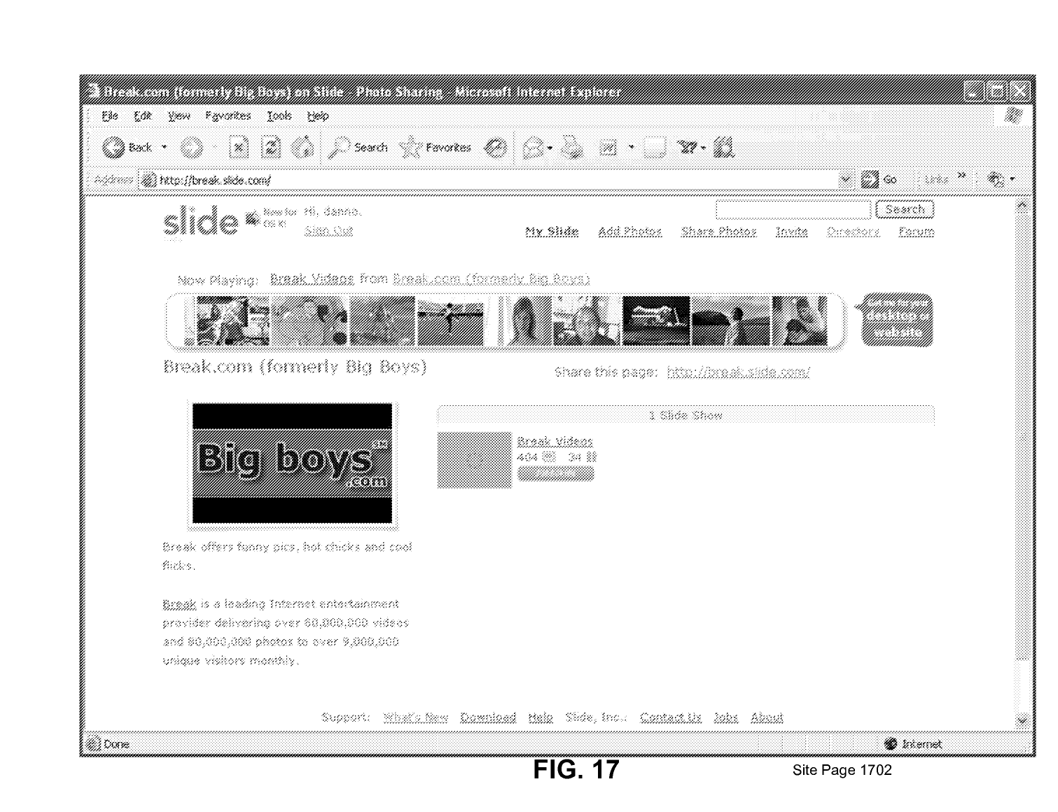

In central media guide 1502, selecting a featured site 1512 or popular site 1514 (e.g., site 1512a), opens a site page such as site page 1702 of FIG. 17. Site page 1702 may act as a guide for the selected site, and may include any number of slide shows, a site poster, a link to an associated website, etc.

Selecting a member in popular members 1516 (or elsewhere) in central media guide 1502 takes the user to a media guide similar to the selected member's local media guide. However, the user will only see information the member has not indicated is private, “invite only” or otherwise restricted. Thus, the user may see a user directory of friends/acquaintances of the member, a directory of slide shows the member is subscribed to and/or that the user publishes for other users to see, etc.

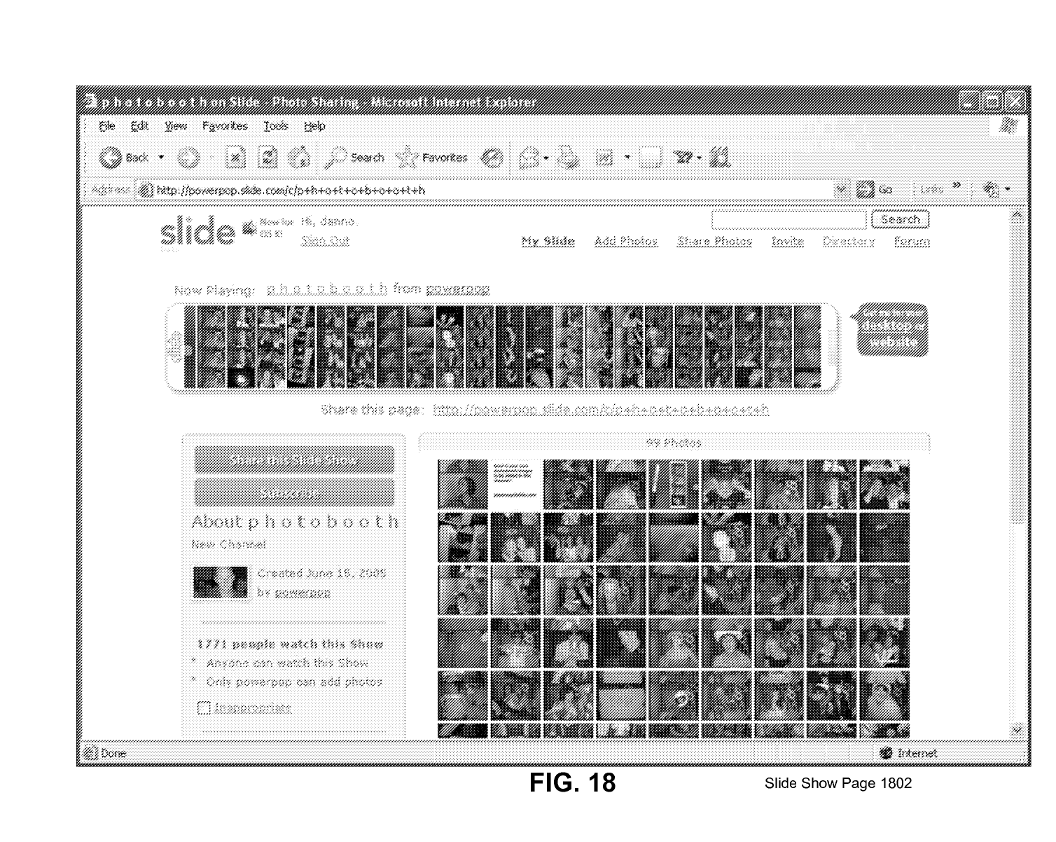

Selecting a slide show from popular slide shows 1518 (or elsewhere) in central media guide 1502 (e.g., slide show 1518a) opens a page such as slide show page 1802 of FIG. 18. In slide show page 1802, the user can see the selected slide show in a media ticker embedded within the page and can also see the individual content items presented in the ticker. A variety of information may also be reported, such as the slide show's publisher, how many users have subscribed to the slide show, whether the show is restricted, etc. Controls may be provided to allow the user to subscribe to the slide show, share the slide show (e.g., notify someone else of the slide show or invite them to subscribe), submit a comment regarding the show, add a content item (if the publisher permits), etc.

A Client Device for Operating a Media Ticker

In one embodiment of the invention, a client device such as a portable or desktop computing device, a smart telephone, a PDA (Personal Digital Assistant), a television or other suitably equipped device is configured to present media content to a user via a media ticker and/or other interfaces.

In particular, the device is configured to receive content items from various sources through an interconnected system of content publishers, content consumers, a provider of a media ticker application and/or other entities. This interconnected system may be termed a media content network because it facilitates the publication and consumption of media content. The media content network may comprise various distinct communication links and networks, including the Internet, local and wide area networks, cable television, dedicated point-to-point links, etc.

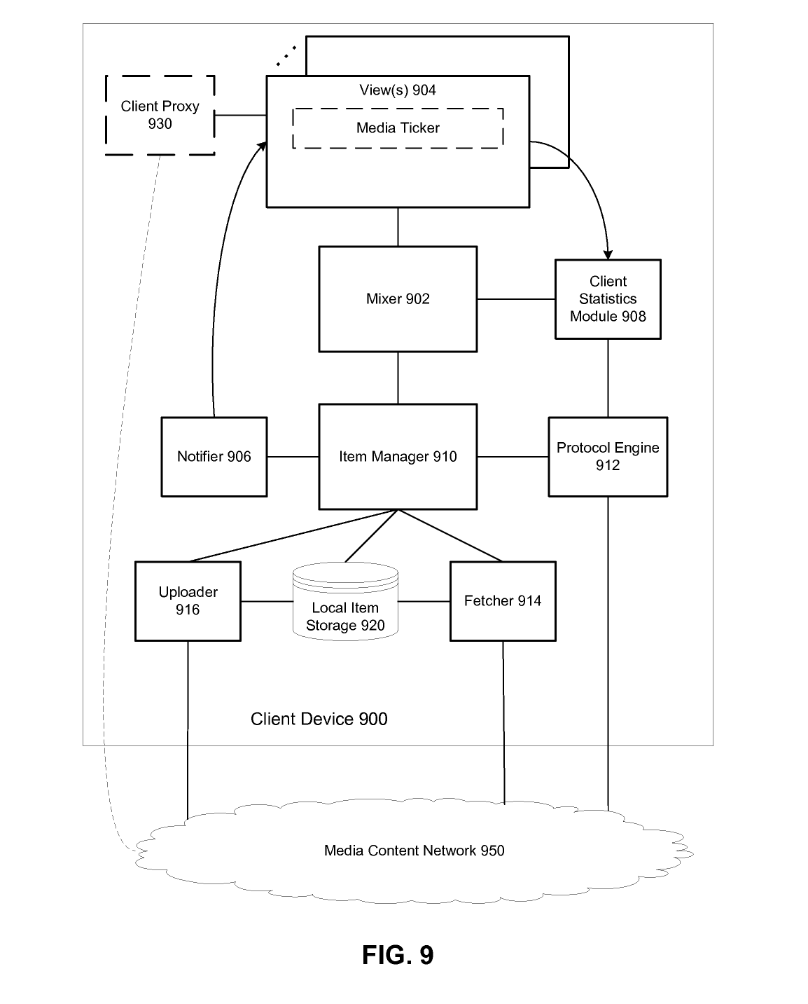

One implementation of a client device is illustrated in FIG. 9. Client device 900 includes various hardware and/or software modules (e.g., Application Program Interfaces or APIs), and may include various other components used in normal operation of the device (e.g., processor, peripherals, operating system), which are not depicted in FIG. 9. The illustrated client device may therefore be primarily used to present media content items to a user, but may serve other functions as well. Further, client device 900 may include all, some or none of the components of media presentation apparatus 700 of FIG. 7.

Within client device 900, mixer 902 is configured to mix different channels of content, or items from different channels of content, for presentation to a user via one or more views 904. At least one of views 904 includes a media ticker or media ticker interface as described in a preceding section, such as ticker 102 of FIG. 1 or ticker 202 of FIG. 2. Other types of views may be provided, to present content items in a slide show, a screensaver or virtually any other format.

Because mixer 902 is responsible for mixing content for presentation, the mixer receives user input regarding content channels, such as when the user turns a channel on or off, subscribes to or unsubscribes from a channel, turns channel interleaving on or off, etc. The mixer may receive the user input via the media ticker application, another module (not depicted) that elicits the user input, or may even comprise a portion of a media ticker application that receives user input.

The mixer can provide to views 904 content items from any channel in any order. As described in a previous section, any number of items from one channel may be presented before the mixer changes to a different channel. Mixer 902 may be programmed to mix content items and channels based on time or number of content items, user preferences (e.g., ranking of different channels), the age of content items (e.g., newer items may be presented first), etc.

Optional notifier 906 presents individual content items, or relatively small sets of content items to a user, to a user. These content items may be presented via a view 904 employed by mixer 902 and/or in separate windows or other graphical interfaces. For example, a content item sent from one user to another (e.g., using a transmit control within an expanded content item as shown in FIG. 2) may be delivered or presented in a display area or window separate from the recipient's media ticker. Notifier 906 may thus open an expanded content item window (or other view) on client device 900, activate an application for accessing the received content, etc.

Thus, in one implementation, notifier 906 delivers time-sensitive content items, while mixer 902 delivers content items that are not time-sensitive.

Client statistics module 908 captures user behavior or statistics (e.g., clicks, mouse-overs), or receives them from view 904. The statistics may be used by mixer 902 to help determine how to mix or sequence content items and content channels. The client statistics module may also forward the user statistics to media content network 950 via protocol engine 912.

Whenever a current media content view needs additional content items (e.g., for scrolling in a media ticker), it informs mixer 902. The mixer turns to item manager 910 to obtain content items for the view.

Item manager 910 is configured to manage the flow of content items to mixer 902 (for consumption) and from client device 900 (for publication). In the illustrated embodiment of the invention, each content item known to the item manager has an associated record that contain metadata such as item name, content channel, publisher, storage location (locally and/or on network 950), size, resolution, data type, age, expiration and so on.

Content items may be stored locally on local storage 920; their associated records may also be retained in storage 920 and/or may be cached by the item manager.

Mixer 902 may request specific content items (e.g., by name) from item manager 910, or may identify certain criteria and simply accept whatever matching items the item manager provides. The criteria may correspond to any metadata the item manager has for the content items. Therefore, the mixer can easily request content items from certain publishers or channels.

Protocol engine 912 is coupled to media content network 950. In one embodiment, the protocol engine is configured to implement a protocol designed to efficiently distribute content items from publishers to consumers. The protocol is thus implemented on every user's client device in order to allow it to receive content items, and on every publisher's computing system or device, to allow it to send content items.

Fetcher 914 and uploader 916 are configured to download content items from network 950 and upload content items to the network, respectively. More specifically, the fetcher and uploader connect to content servers and repositories to retrieve or store content items as directed by item manager 910.

In the illustrated embodiment of the invention, when a content item is to be downloaded, item manager 910 instructs protocol engine 912 to obtain a content item record or other description of the item. That record or description may identify the content item (e.g., by filename), the item's storage location (e.g., the content server on which the item is stored) and/or other metadata (e.g., type of media data, size, resolution).

Based on the content item's record, the item manager instructs fetcher 914 to fetch the content item. The content item may be fetched directly from its publisher (e.g., another user, a commercial website) or an intermediate or central repository within media content network 950 (e.g., a cache of content items). The content item and/or its metadata may be stored in local storage 920.

When a content item is ready to be published from client device 900, item manager 910 or protocol engine 912 constructs a record for the item, and the protocol engine submits the record to a network protocol engine. If the content item is to be stored in a network repository, protocol engine 912 is instructed where (e.g., on which media content server) the content item is to be stored, and uploader 916 is instructed by the item manager to upload the item accordingly. Alternatively, the item may be uploaded only when needed (e.g., when it is to be consumed by another user).

In the embodiment of the invention illustrated in FIG. 9, client proxy 930 allows a user to enjoy media items stored locally (e.g., on storage 920) to be accessed even when no connection is available to media content network 950. In this embodiment, a view 904 includes a web browser with various controls for controlling the presentation of content items (e.g., as shown in FIGS. 1-2). Those controls may be configured to invoke a web server (within media content network 950) if a network connection is available. However, those controls are also configured to invoke client proxy 930 rather than a web server (e.g., if no network connection is available or if faster performance is desired). The client proxy thus acts like a web server to the view's web browser.

Items on client 900 can also be prepared for publication with client proxy 930. For example, bindings can be created and item manager 910 can create records for new content items while client 900 is offline, and the items can then be published asynchronously when a connection is again available.

A Television-Based Media Ticker

In some embodiments of the invention, a media ticker or other interface described herein for presenting media to a user is rendered on a television, a mobile telephone or other device having a display component. References in this section to the use of a television for the presentation of a media ticker, slide show or other content interface should be understood to include any such device capable of displaying television programming and/or other types of media content, regardless of whether or not the device also receives information via a data connection.

In particular, in embodiments of the invention described in this section, a “television” may include a display device (e.g., plasma, LCD, LED, CRT) capable of rendering television programming received via cable TV, satellite TV, wireless broadcast and/or other means (e.g., the Internet), but may also be capable of displaying information received from a computer or computing device.

For example, the television maybe a traditional television that is coupled to a television input (e.g., cable, satellite, broadcast), perhaps via interface equipment (e.g., cable set-top box, satellite transceiver, antenna), but is operated in a relatively stand-alone mode. As another example, the television may also, or instead, be coupled to a computer system as a primary or alternate display device, and operation of the television may be controlled through traditional means (e.g., a remote control) and/or the computer.

Equipment coupled to the television (e.g., cable set-top box, satellite transceiver, digital video recorder, computer) may comprise processors, user interfaces, storage and other components. Therefore, the various functions described herein, such as receiving television programming, receiving content for display in a media ticker, feeding a ticker and content items to the television, and so on, may be performed by different equipment in different embodiments of the invention. Alternatively, the television itself may comprise some or all of the components necessary to receive, process and display a media ticker and associated content in conjunction with television programming.

Embodiments of the invention described in previous sections may also encompass the presentation of a media ticker on a television, and may thus partially or fully overlap embodiments described in this section. And, a method or apparatus described in this section for presenting a media ticker and content may be applied in embodiments described in previous sections.

In one embodiment of the invention, a television program may be displayed in a traditional fashion, as received via a cable set-top box or satellite transceiver, for example. The media ticker, and content to be displayed in the media ticker, may be input to the television via a computer coupled to the television, via the equipment that feeds the television signal (e.g., the cable set-top box, the satellite transceiver), or other equipment.

In particular, the two types of input to be simultaneously displayed on the television (e.g., television programming, media ticker content) may (but need not) be delivered via different transmission media (e.g., cable, satellite, telephone, the Internet), or via different channels of the same medium. In one implementation, a television provider (e.g., cable network, satellite broadcaster) may provide content for a media ticker as a separate service feature, or as a special channel.

A media ticker and content items presented on a television may be subject to a range of manipulation by a user or viewer, similar to embodiments of the invention described previously, depending on the type or configuration of the television. Thus, a user may control the display or operation of a media ticker on a television through a computer coupled to the television, through a television remote control, through a web TV type of control, through a specialized remote control, and/or via other means.

An application for generating and/or controlling the media ticker and feeding content items to the television for display within the ticker may execute on the user computer, cable set-top box, satellite transceiver or other equipment that provides the media ticker input to the television. In one alternative embodiment, the television itself has the ability to generate a media ticker (and may be programmable to alter the ticker), and simply presents within the ticker whatever content items are received in the appropriate format.

In an illustrative implementation of an embodiment of the invention suitable for use with a television, a media ticker may be presented in an unused (or under-used) portion of the television screen. For example, when a television program is displayed in a “letterbox” format, some area above and/or below the program may be blank. Similarly, a program displayed in a “windowbox” format leaves blank space to either or both sides of the program. Thus, a media ticker may be presented in the blank space—perhaps with a horizontal aspect when accompanied by a letterbox program or a vertical aspect with a windowbox program.

In another implementation, a media ticker may be presented virtually anywhere on the television. It may be overlaid upon the underlying program or may be presented in a separate frame, akin to “picture in picture”, and may be movable within the television display.

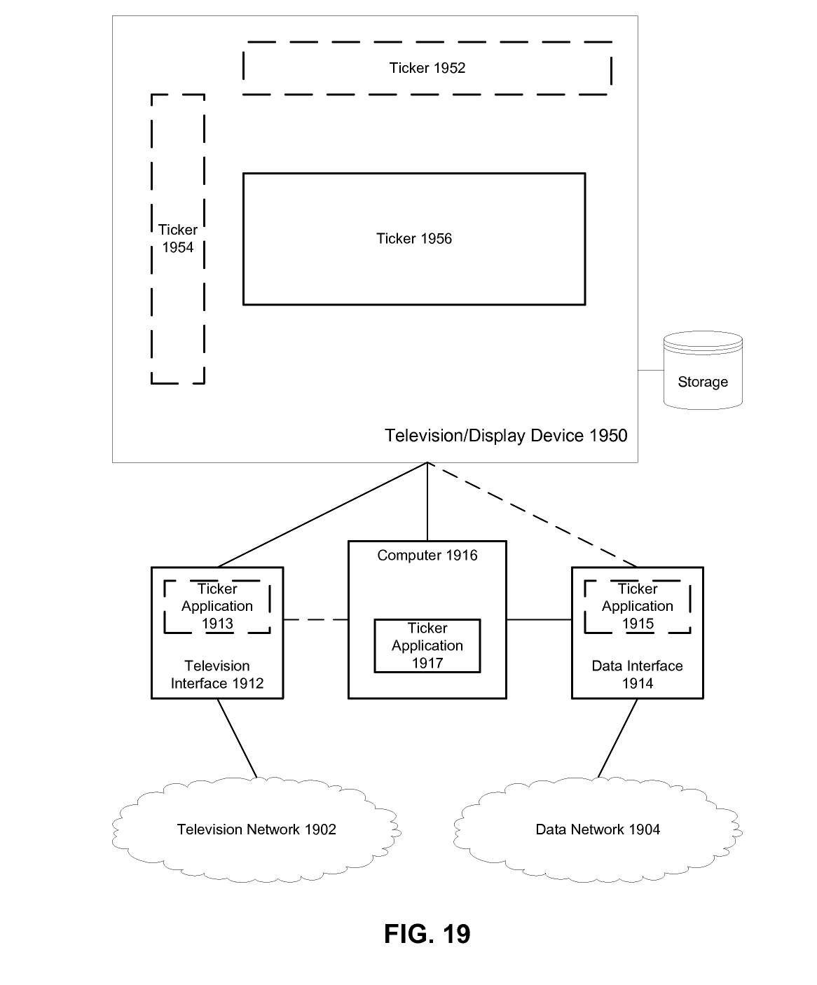

FIG. 19 is a block diagram of an illustrative embodiment of the invention, in which television programming (e.g., movies, sporting events, television shows, news, commercials) is received via one set of interface equipment, while content for display in a media ticker is received via a different interface.

In particular, in the embodiment of FIG. 19, television programming from television network 1902 is received by a user via television interface 1912, for display on television or display device 1950. The television interface may comprise a cable television set-top box, a satellite transceiver, equipment for receiving a television signal via telephone lines, an antenna, etc. Thus, the television programming may be received in various forms (e.g., wired, wireless) and formats (e.g., analog, digital, high definition).

Data communications from data network 1904 (e.g., the Internet, an intranet, a municipal network, a home network) is received at data interface 1914, which may comprise a cable modem, a DSL (Digital Subscriber Line) modem, a telephone modem, a satellite transceiver, etc. In the illustrated embodiment of the invention, content for display on television 1950 within a media ticker is received via data interface 1914. In one alternative embodiment of the invention, television interface 1912 and data interface 1914 are embodied in a single interface.

Data interface 1914 is coupled to computer 1916, via a wired or wireless link, which may be dedicated or shared (e.g., via a network), while television interface 1912 is coupled to television 1950. In alternative embodiments of the invention, television interface 1912 may also, or instead, be coupled to computer 1916. For example, television 1950 may serve as a display device for the computer, or content items for presentation in a media ticker may be received via the television interface. Also in an alternative embodiment, data interface 1914 may be connected directly to television 1950 in addition to (or instead of) being coupled to computer 1916. In yet other embodiments, television network 1902 and/or data network 1904 may be directly coupled to television 1950.

On computer 1916, ticker application 1917 executes to generate and/or control a media ticker, which may be similar to a media ticker described in a previous section. Illustratively, the ticker application allows the appearance of a media ticker (e.g., size, shape, color, other design features) to be customized based on various factors, such as the television programming that accompanies the media ticker (which may be learned via data network 1904), a provider (e.g., television station or network) or sponsor of the television programming, user preferences, etc.

Content presented via the media ticker may also be selected based on these or other factors. For example, a given slideshow (e.g., set of content items) may be specifically recommended or assembled for presentation with a particular television program. Or, substantially the same content may be presented to accompany different television programs.

In the embodiment illustrated in FIG. 19, ticker application 1917 is responsible for transmitting the media ticker to television 1950 and presenting within the ticker content received via data interface 1914. Computer 1916 (and/or television 1950) may thus include any amount of storage (e.g., memory, disk) for short-term or long-term storage of content items. For example, for a content channel whose content items are relatively static (e.g., the user's favorite photos, a set of photos shared by a friend), some or all of the content items may be cached on computer 1916 for any period of time, so that they do not need to be continually downloaded from data network 1904. Conversely, a set of content items may be downloaded just for presentation during the current television program, in which case they need not be retained for long. At another extreme, virtually every content item to be presented in the media ticker may be downloaded to computer 1916 via data interface 1914.

On television 1950, media tickers 1952, 1954, 1956 represent illustrative locations or positions at which a media ticker may be displayed on a television screen. As described above, tickers 1952, 1954 may be well suited for use with a program in letterbox or windowbox format, respectively. Ticker 1956 may be suited for presentation on a blank television channel, during a program that has no video (e.g., a concert, a music station), or as a picture in picture mode of operation.

A media ticker may normally be presented in as unobtrusive a location as possible (e.g., as ticker 1952 or 1954), but may become temporarily prominent (e.g., like ticker 1956) at certain times. For example, the ticker may take on a more prominent appearance when it is manipulated—e.g., to expand it, to change its appearance or behavior, to enlarge a content item or the entire media ticker, and so on.

In the embodiment of the invention depicted in FIG. 19, one or more storage devices or components are used to store content items, tickers, metadata and/or other information used during the presentation of a media ticker. Such storage may be directly connected to television 1950, as an external disk drive or other type of storage device, or may be included within the television or some other hardware/software component coupled to the television (e.g., computer 1916, television interface 1912, data interface 1914, a DVR, an Xbox, Apple TV, Web TV).

Presentation of a media ticker may thus be controlled in various manners, depending on where the media ticker application executes. In FIG. 19, the application executes on computer 1916, thereby allowing a user of that computer to affect its size, position, speed with which content items are scrolled, direction of scrolling, etc.

In other embodiments, greater or lesser control of the media ticker may be possible. For example, in alternative embodiments of the invention in which a ticker application executes on television interface 1912 (as application 1913) or data interface 1914 (as application 1915), a user may have less (or no) control over a media ticker. In another alternative embodiment, in which a ticker application executes on television 1950, control may be had only through the television's remote control (and/or manual controls on the television). In these alternative embodiments, computer 1916 may or may not be omitted.

As described above, content for a media ticker presented on a user's television may be received via virtually any input source connected to the television. A television program displayed on the television may be received via one channel or source, and content for the media ticker may be received via a different channel or source. Sources of the television program and media content may coordinate their deliveries (e.g., to have a particular content item presented with a particular program, to ensure the media ticker is not placed in an obtrusive portion of the television display area), but this is not necessary.

In one embodiment of the invention, however, wherein the sources of television program and media ticker content do not coordinate their deliveries, the equipment that feeds content items and/or the media ticker to the television may be capable of identifying the television program being displayed, or at least its type (e.g., commercial, sporting event, movie). For example, in FIG. 19, computer 1916 may obtain a schedule of television programming via data network 1904, and/or learn from television 1950 or television interface 1912 what program is being watched at a given time.

This information may affect the content that is fed to the television for display within the media ticker. Illustratively, select content items may be chosen based on their relevance to the television program, the likelihood that a viewer interested in the program would also be interested in the content items, and/or virtually any other factor. Alternatively, the content items that are presented may be selected randomly or without regard to the television program.

The behavior of a media ticker may be altered automatically depending on the television program being displayed. For example, content items may scroll faster during a commercial than during a non-commercial, the media ticker (and content items) may enlarge during a commercial, scrolling of content may pause while a user changes stations or accesses a television guide, etc.

A media ticker or content presented within the media ticker may or may not be recorded to a DVR (Digital Video Recorder) or other storage device when a television program that the media ticker accompanies is recorded. Even if it is recorded, different content items may be presented when the recording is played. Similarly, a media ticker may be presented during the playing of a recorded program even if no media ticker had been recorded with the program.

In different embodiments of the invention, different methods may be employed to deliver and present a media ticker and content items to a user's television or other capable device. For example, in some embodiments a user having a smart device such as WebTV, Apple TV or a suitably configured computer system could access a ticker via the Internet in a manner similar to methods described above for presenting a media ticker on a computer system.

In other embodiments, a cable provider, a telephone service provider or other data provider might deliver tickers and/or content in an “on demand” or “pay per view” manner. In yet other embodiments, a publisher may purchase or sponsor a particular channel through which it could broadcast content.

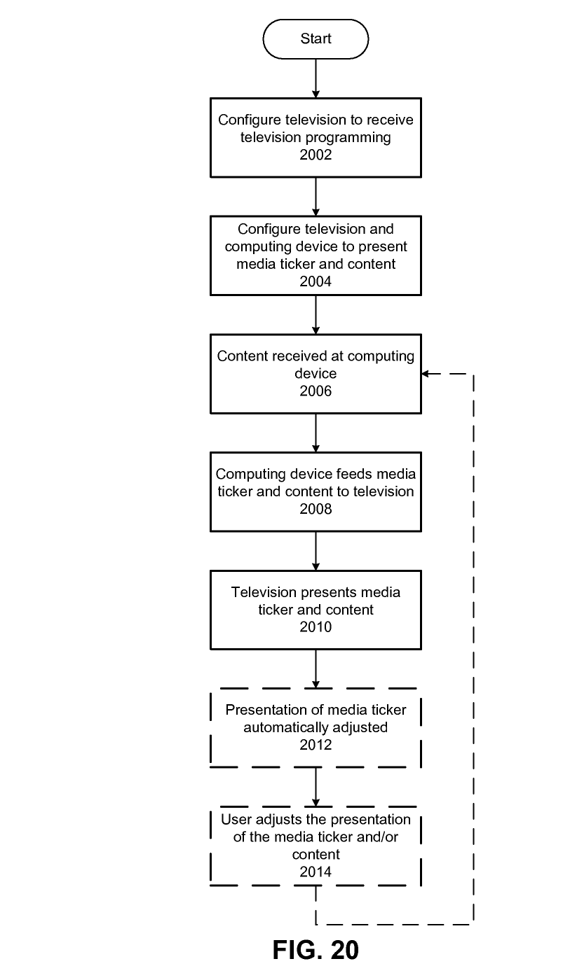

FIG. 20 is a flowchart demonstrating an illustrative method of presenting a media ticker on a television, according to one embodiment of the invention.

The method illustrated in FIG. 20 may be implemented in an environment such as that depicted in FIG. 19, wherein television programming or content is received via one path (e.g., via a television service provider), while content for presentation within a media ticker is received via a different path (e.g., via an Internet service provider or other data provider).

In operation 2002, a user's television is configured to receive television programming. The particular configuration employed may depend upon the user's television service provider. For example, a satellite receiver or cable set-top box may be installed and configured to receive television via satellite or cable, respectively. Or, if the television possesses its own tuning equipment, the television input may be plugged directly into the television (e.g., without a set-top box or satellite transceiver).

In operation 2004, the television is configured to receive data communications via a suitable source (e.g., an Internet service provider, a different channel of the provider of the television programming). As with the television interface, suitable data network interface equipment (e.g., DSL modem, cable modem) may be installed and configured. Embodiments of the invention described herein are not limited to use with any particular methods of delivery of television programming and data other than television programming.

In the illustrated embodiment of the invention, the data network is coupled to a computer or other computing device that is in turn coupled to the television, and the computing device is responsible for generating and transmitting the media ticker to the television. Content for presentation within the media ticker may also be fed to the television via the computing device, or the television may be coupled directly to the data network equipment to receive the content.

In one alternative embodiment in which the television is coupled directly to the data network interface equipment, the television is programmed (and may be reprogrammable) to generate a media ticker in which to present content received via the data network. Thus, in this alternative embodiment, the television may not need to receive the media ticker from a computing device.

In particular, whether the media ticker is delivered to the provider of the television content (e.g., the cable company), who then delivers it with content to the television as one video package, or the television programming is received by a separate network (e.g., an internet service provider) who combines it with a media ticker and delivers them to the television as one, is immaterial.

In operation 2006, the computing device begins receiving content for display within a media ticker, and may also receive a media ticker, or information that will affect the appearance of the media ticker transmitted to the television from the computing device. For example, different media tickers may be presented at different times (e.g., depending on which television channel or program is being displayed on the television, or which content channels are active), and the computing device may receive different media tickers from time to time, or instructions on how to modify a media ticker.

In one implementation, the computing device may receive regular, periodic or even continuous deliveries of content via the data network. The content that is delivered may depend upon the content channels the user has subscribed to, a television program currently being received by the television, the television channel being displayed, characteristics or demographics of the user, or virtually any other factor.

A given content item may be received with special instructions regarding how it is to be presented. For example, a content item may be coded for slower (or faster) scrolling, enlarged size (relative to other items), pausing of the media ticker to allow more time for the user to observe the item, etc.

Content may be received and stored on the computing device once and then repeatedly presented in the media ticker. For example, when a set of content items is received, it may simply be presented in the media ticker over and over until the next set of content items is received to replace the previous set. Or, individual content items may have associated lifetimes, at the expiration of which the computing device stops feeding them to the television for presentation.

In one implementation, some content items may be relatively permanent or semi-permanent, such as content within channels that the user has subscribed to. Those content items may be repeatedly presented as long as the corresponding channel is active (e.g., the user has not made the channel inactive). Other content items, which may be specific to a television program or channel, date, time of day, or other factor, may only be presented while the corresponding program or channel is being played, or during the corresponding date, time, etc.

In operation 2008, the computing device begins transmitting a media ticker and content to the television, for presentation to the user. The media ticker may be transmitted with content items included, or the content items may be transmitted separately.

For example, in one implementation in which the television is equipped with suitable processing components (e.g., a central processing unit, memory), a media ticker may be transmitted to the television once and then stored and displayed from memory. As content is received for the media ticker, it is simply added to the display. Or, content may also be cached on the television. Different media tickers may be transmitted as needed or desired, with different designs, orientations, branding or other characteristics. Processing components included in the television to enable this implementation may be separate from, or may include, any DVR capability (or other capability for recording television programming) that the television or other connected equipment possesses.

As another example, the computing device may provide a continuous stream of video input comprising the media ticker, which the television simply receives and displays, similar to television programming. The content for presentation within the media ticker may be merged at the computing device with the media ticker input so that a single stream of input is sent to the television, or may be provided as a separate input.

Thus, in different embodiments of the invention, the appearance of the media ticker and content items may be controlled at either or both the computing device and the television, depending on the television's processing capabilities and/or other factors. In particular, the television may simply display whatever the computing device transmits, in which case the computing device will be entirely (or mostly) in control of the size of the ticker and content items, how/where it is displayed on the television, and any other characteristics. As another possibility, the television may be able to adjust its presentation of the media ticker (e.g., size, location, color) on its own initiative or in response to instructions from the computing device.

In operation 2010, the television presents the media ticker and content on the television screen. The media ticker may be of virtually any size and orientation (e.g., vertical, horizontal, diagonal, curved, free-form) and may present any number of content items at a time. The content items may scroll in any direction within the media ticker, at any speed.

In optional operation 2012, the media ticker may be altered automatically in response to some event if the computing device receives information regarding the television program or channel the user is watching. For example, the television service provider may transmit this information via the data network, or the television (or television network interface) may supply this information.

In one implementation, when the computing device learns or determines that a commercial is being played, it may begin sending an enlarged media ticker and content items to the television, may have the media ticker repositioned to a more prominent location on the television screen, may have the content items scroll faster, may send one or more content items coded for presentation during a commercial, etc. When the regular television program resumes after the commercial, the media ticker may return to its previous size, location, scroll speed, etc.

In optional operation 2014, the user takes some action to affect the presentation of the media ticker. The extent to which the user can affect the presentation may depend upon the system configuration.

For example, in an implementation in which the television is relatively passive and simply displays whatever the computing device transmits to it, the user may adjust many different aspects of the presentation by interacting with the media ticker application executing on the computing device. The user may be able to change the size, orientation, location, scroll speed or other aspect of the media ticker, for example. At the computing device, the user may also be able to subscribe or unsubscribe to/from a content channel, activate or deactivate a channel, inject a content item into a channel being presented in the media ticker (if she has appropriate access rights), view an item presented (or in queue to be presented) in the media ticker, copy an item from a channel, etc. In this implementation however, the user may not be able to affect the media ticker presentation via a television remote control (or controls on the television itself), or may only be able to take simple actions (e.g., turn the media ticker on or off, reposition the media ticker).

In an implementation in which the television is relatively intelligent, the user may be able to use the television remote control to modify the media ticker presentation to a greater extent. The remote control may be configured so that certain buttons or combinations of buttons will change the speed or direction of the ticker, enlarge items within the ticker, cause files in the ticker to open or execute (e.g., video or audio files), or to change the primary content being displayed on the television from the television programming to a web site linked from an item in the ticker. Each of these actions may be configured so that the television program is paused, resized or recorded during the period when the ticker is being manipulated.

In the embodiment of the invention illustrated in FIG. 20, the presentation of the media ticker and content may continue as long as the television is on. Additional or replacement content items may be received with any regularity, as indicated by the return to operation 2006. Alternatively, presentation of the media ticker may be limited, perhaps by only appearing during particular television programming (e.g., commercials, sporting events), or by being omitted during certain programming (e.g., movies), or may be limited based on which television channel or channels are watched, the time of day, user identity, etc.

In other embodiments of the invention, methods of presenting media tickers on televisions may differ from the method depicted in FIG. 20. For example, in one alternative embodiment, a television program and a media ticker (and media ticker content) may be received via a user's television service provider. The program may be received on one channel or station, while the media ticker is received on a second channel or station. Either transmission may be accompanied with signaling indicating how or where on the television screen to display the media ticker, or the media ticker transmission may simply be overlaid on the television program. In this embodiment, because the media ticker is provided by the television service provider, a remote control or other control for manipulating the television program (e.g., changing channels, adjust sound or video) may also include controls for manipulating the media ticker (e.g., size, scroll speed, pause).

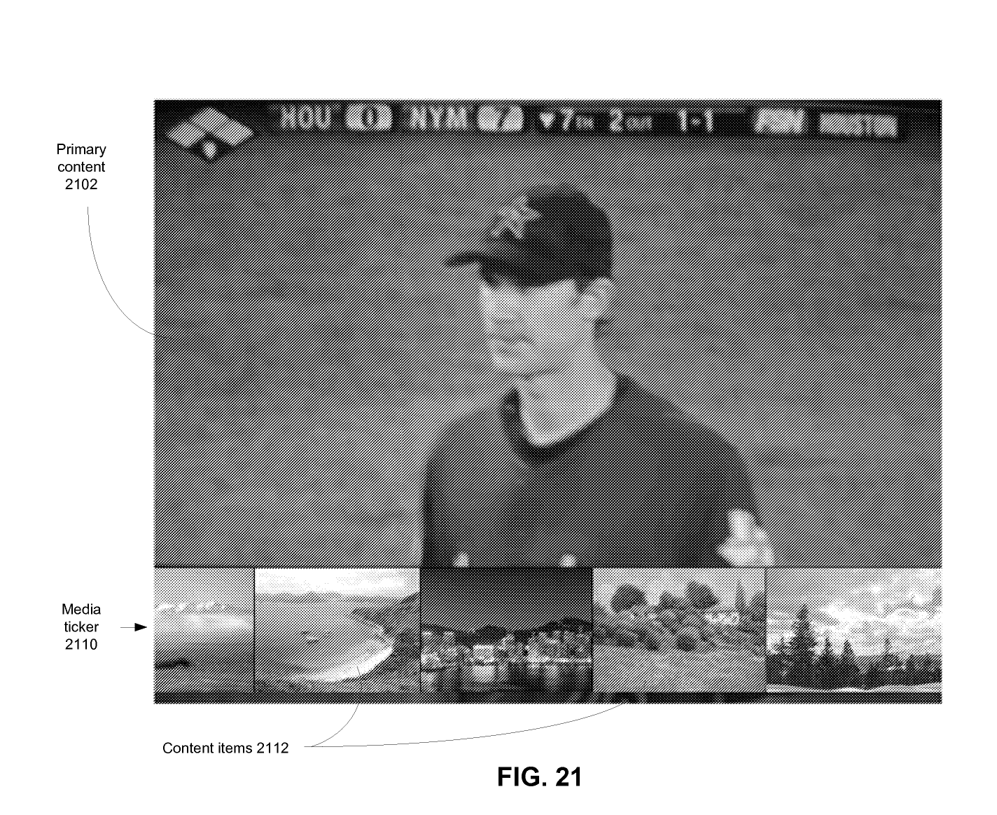

FIG. 21 depicts a media ticker as it may appear on a television or other display component in one embodiment of the invention. In this embodiment, media ticker 2110 is superimposed over the primary content 2102 being played on the television. Media ticker 2110 has a horizontal orientation, so that content items 2112 can scroll horizontally from right to left or vice versa.

A user or viewer may be able to modify media ticker 2110 (e.g., via his or her computer, with a remote control) to adjust the location and/or orientation of the media ticker, alter the speed with which the content items scroll, adjust other characteristics of the content items (e.g., size, number), etc. Instead of scrolling, the media ticker may be adjustable to have the items change in some other manner. For example, the content items may step or jump from one position to another within the ticker, may fade in and/or out, etc.

In one alternative embodiment of the invention, content items 2112 of media ticker 2110 need not be adjacent to each other. For example, one or more predetermined or adjustable locations on the television display may be selected (e.g., the corners, midpoints of each of the four sides), and the content items may move or jump from one position to another. In effect, each separate position may operate (and be configurable) as a separate media ticker designed to display a single content item at a time. The position(s) may be selectable by a user, or may be automatically selected to avoid areas of primary content 2102 that change most often. Such areas may encompass the focus of action of the primary content—areas that the viewer may not wish to be obscured.

In FIG. 21, media ticker 2110 is not positioned at the very bottom of the television display, although it may in other embodiments. Illustratively, the space between media ticker 2110 and the bottom of the display may be configured (e.g., sized) to allow a ticker-type stream of news headlines, stock prices and/or other information to be displayed without blocking content items 2112.

As described previously, content items 2112 may comprise images the viewer enjoys, photographs published in a content channel to which the viewer has subscribed, previews of content being presented on television channels other than the channel supplying primary content 2102, and so on. In one implementation, the viewer may be able to swap primary content 2102 with a content item 2112 (or take other action) by manipulating a remote control or an interface device coupled to the television (e.g., television interface 1912, data interface 1914 or computer 1916 of FIG. 19).

In different embodiments of the invention, a media ticker presented on a television may be configured by the user to deliver user-selected content, by an internet service provider to deliver content that is relevant to the user based on the user's identity or the accompanying television program (or other factor), by a television delivery system (e.g., the cable company) to deliver content that is geographically or contextually relevant to the television program, or by some other entity.

In each of these cases, the size, speed and configuration of the ticker may be different. For example, user-selected content may always in blank space created by letter box presentations, while contextually relevant content may overlap with the television content during commercials or when the content in the media ticker would be of greater interest to the user than the television program (such as delivery of images from a disaster occurring during a news broadcast of that event). Furthermore, the ticker may facilitate access to related websites with more information about presented content, charitable or other fundraising websites related to the content, or retail outlets selling items of interest to the user, including items included in the television programming and in accompanying advertisements.

In one alternative embodiment of the invention, a media ticker may be presented on a television or similar display (e.g., a computer monitor) while the television (e.g., or computing device) plays audio content. For example, some providers (e.g., television service providers, satellite service providers) offer audio channels to subscribers, and different channels may correspond to different genres of music (e.g., jazz, classical, techno, pop). When a subscriber tunes to such a channel, music is played and the television may be blank, may present a static display or some other minimal video content. In this embodiment of the invention, the media ticker is presented while the audio is played and may operate and/or be manipulable in a similar or different fashion as in other embodiments of the invention described above. A service provider may even offer media ticker content tailored for the genre of audio being played, such that different content is presented during different songs or types of music, or on different television channels.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A method of presenting electronic content to a user via a media ticker interface displayed on a television, the method comprising:
receiving at the television a first stream of data comprising a television program;
receiving at the television a second stream of data comprising graphical objects corresponding to multiple electronic content items belonging to one or more content channels;
playing the television program on the television; and
during said playing of the television program:
presenting the media ticker on the television;
displaying a first graphical object in a first position within the media ticker;
moving the first graphical object, within the media ticker, to a second position, wherein the first graphical object is displayed during said moving; and
at the second position, removing the first graphical object from the media ticker;
wherein said displaying, moving and removing are repeated for one or more additional graphical objects in the second stream of data.

2. The method of claim 1, wherein the first stream of data is received from a television service provider.

3. The method of claim 2, wherein the second stream of data is received from the television service provider.

4. The method of claim 1, wherein the second stream of data is received from a data network access provider.

5. The method of claim 1, wherein the first stream of data and the second stream of data are simultaneously received via different channels of a single communication connection.

6. The method of claim 1, wherein a graphical object corresponding to a content item comprising an image comprises a version of the image displayable within the media ticker.

7. The method of claim 1, further comprising during said playing:
presenting a stationary view of a graphical object or the corresponding content item after said displaying and before said removing of the graphical object.

8. The method of claim 7, wherein the stationary view comprises an enlarged view of the content item.

9. The method of claim 1, wherein a graphical object displayed in the media ticker comprises one or more of the group of:
an image;
a photograph;
a drawing;
an infographic;
a link to a web site;
a chart; and
text.

10. The method of claim 1, wherein a graphical object displayed in the media ticker comprises one or more of the group of:
a key frame;
a screen shot; and
a thumbnail.

11. The method of claim 1, further comprising:
providing an alternate mode of operation of the media ticker; and
for one or more of the graphical objects, during said alternate mode of operation:
pausing said moving of the graphical object; and
displaying the graphical object with a size larger than a size with which it was displayed within the media ticker.

12. The method of claim 1, further comprising:
receiving a signal from a remote control operated by the user while the first graphical object is displayed;
in response to the signal, retrieving additional content stored remotely from the television; and
displaying the additional content.

13. A computer readable medium storing instructions that, when executed by a computer, cause the computer to perform a method of presenting electronic content to a user via a media ticker interface displayed on a television, the method comprising:
receiving a first stream of data comprising a television program;
receiving a second stream of data comprising graphical objects corresponding to multiple electronic content items belonging to one or more content channels;
playing the television program on the television; and
during said playing of the television program:
presenting the media ticker on the television;
displaying a first graphical object in a first position within the media ticker;
moving the first graphical object, within the media ticker, to a second position, wherein the first graphical object is displayed during said moving; and
at the second position, removing the first graphical object from the media ticker;
wherein said displaying, moving and removing are repeated for one or more additional graphical objects in the second stream of data.

14. A method of facilitating the presentation of interactive media content items on a device capable of playing multimedia content, the method comprising:
transmitting a media ticker to the device; and
transmitting one or more content items for playing on the device within the media ticker;
wherein during a first mode of operation of the device the media ticker is displayed on the device and a content item is presented within the media ticker; and
wherein during a second mode of operation of the device initiated in response to a selection of a first content item, additional content is retrieved and presented on the device, the additional content comprising content not presented on the device at the time the first content item is selected.

15. The method of claim 14, wherein the first content item comprises a link to a website and the additional content comprises content from the website.

16. The method of claim 14, wherein:
the device comprises a television; and
the first content item identifies a program available on a channel other than a channel being played on the device at the time the first content item is selected.

17. The method of claim 14, wherein:
the device comprises a television; and
during the first mode of operation a first television program is presented on the device simultaneously with the media ticker.

18. The method of claim 17, wherein during the second mode of operation a television program identified in the first content item is presented in place of the first television program.

19. The method of claim 17, wherein during the second mode of operation the first content item is presented in place of the first television program.

20. A method of presenting electronic content to a user via a media ticker interface displayed on a television, the method comprising:
delivering an audio stream to a television, unaccompanied by a television program; and
delivering to the television a data stream comprising graphical objects belonging to one or more content channels;
wherein during said playing of the audio stream:
a media ticker interface is displayed on the television;
a first graphical object is displayed in a first position within the media ticker;
the first graphical object is moved within the media ticker to a second position, wherein the first graphical object is displayed during said moving; and
at the second position, the first graphical object is removed from the media ticker;
wherein one or more additional graphical objects in the data stream are displayed, moved and removed.

21. A system for presenting content to a user in a media ticker displayed on a television, comprising:
the television, having a screen;
a television interface coupling the television to a television network to facilitate receiving a television program to display on the screen;
a content interface configured to facilitate receiving multiple electronic content items;
the media ticker, configured to scroll a content item through a portion of the television screen comprising said media ticker; and
a media ticker application configured to generate the media ticker for display on the television screen.

22. The system of claim 21, wherein the television comprises the media ticker application.

23. The system of claim 21, further comprising a computing device coupled to the television, wherein the computing device comprises the media ticker application.

24. The system of claim 21, wherein:
the television interface and the content interface couple the television to a television provider; and
the television program and the content items are received via different communication channels.

25. The system of claim 21, wherein:
the television interface couples the television to a television provider; and
the content interface couples the television to a data provider.
